(19) United States
(12) Patent Application Publication
(10) Pub. No.: US 2016/0067547 A1
(43) Pub. Date: Mar. 10, 2016

(54) METHODS AND SYSTEMS FOR AUTOMATIC ADVERSE EVENT DETECTION AND ALERTING

(71) Applicant: Tagit Labs, Inc., Old Saybrook, CT (US)

(72) Inventors: John Joseph Anthony, East Lyme, CT (US); Scott Edward Chalfant, Andover, CT (US)

(73) Assignee: TAGIT LABS, INC., Old Saybrook, CT (US)

(21) Appl. No.: 14/846,225

(22) Filed: Sep. 4, 2015

Related U.S. Application Data
(60) Provisional application No. 62/045,639, filed on Sep. 4, 2014.

(51) Int. Cl. A63B 24/00; G01P 15/00

(52) U.S. Cl. CPC A63B 24/0003; G01P 15/00

(57) ABSTRACT

A method according to a set of instructions stored on the memory of a computing device can include receiving first motion sensor data of a motion sensor associated with a sporting good. The method may further include activating an activity monitoring application logic. The activity monitoring application logic may include receiving a second motion sensor data of the motion sensor after the activity monitoring application logic is activated. The activity monitoring application logic may further include processing the second motion sensor data to identify a pattern of motion indicative of active usage of the sporting good. The activity monitoring application logic may further include activating adverse event detection logic. The adverse event detection logic may include receiving third motion sensor data of the motion sensor. The adverse event detection logic may further include monitoring the third motion sensor data to detect a potential adverse event experienced by the sporting good.

### CROSS-REFERENCE TO RELATED PATENT APPLICATION

This application is claims priority to provisional U.S. Patent Application No. 62/045,639 filed on Sep. 4, 2014, the entire contents of which are incorporated herein by reference.

### BACKGROUND

Many people engage in outdoor activities and sports, such as cycling, hiking, skateboarding, motor sports, water sports, snow sports etc. Such sports and activities may be participated in as a leisure activity. Such sports and activities may also be participated in for utilitarian purposes, such as transportation. In other words, a person may, for example, cycle to work or to meet someone at a restaurant for dinner.

In order to remain safe when participating in such activities and sports, persons often wear safety equipment, such as helmets, reflectors, lights, elbow and/or knee pads, gloves, and/or other protective clothing. Additionally, persons often devote much time and effort to ensure that their equipment (e.g., skis, motor vehicle, bicycle) is well maintained and functioning properly to ensure that such equipment can be used safely and enjoyably.

Other steps are also taken to ensure that users of outdoor sporting equipment and vehicles can do so safely. For example, product liability laws help incentivize manufacturers to build sporting goods that function properly. Government bodies install dedicated bicycle lanes in roadways to protect bicyclists. Safety laws such as mandatory motorcycle helmet laws help prevent or reduce head injuries for motorcyclists who are involved in an accident.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method according to a set of instructions stored on the memory of a computing device. The method includes receiving, by a processor of the computing device, first motion sensor data of a motion sensor associated with a sporting good. The method further includes, in response to the first motion sensor data, automatically activating, by the processor, an activity monitoring application logic. The activity monitoring application logic includes receiving, by the processor, a second motion sensor data of the motion sensor after the activity monitoring application logic is activated. The activity monitoring application logic further includes processing, by the processor, the second motion sensor data to identify a pattern of motion indicative of active usage of the sporting good. The activity monitoring application logic further includes, in response to identifying the active usage, automatically activating, by the processor, adverse event detection logic. The adverse event detection logic includes receiving, by the processor, third motion sensor data of the motion sensor. The adverse event detection logic further includes monitoring, by the processor, the third motion sensor data to detect a potential adverse event experienced by the sporting good.

In some implementations of the method, the activity monitoring application logic is automatically activated based at least in part on a determination that the first motion sensor data indicates that the sporting good has moved.

In some implementations, the method can include, in response to determining the potential adverse event, monitoring the third motion sensor data for indicia of a return to active usage of the sporting good.

In some implementations, the method can include, in response to a failure to detect the return to active usage of the sporting good within a threshold amount of time, initiating an adverse event notification process.

In some implementations, the method can include, in response to initiation of the adverse event notification process, sending an adverse event alert to a predetermined emergency contact. The adverse event alert can include a location of the motion sensor.

In some implementations of the method, the potential adverse event is detected by processing the third motion sensor data to obtain an orientation of the sporting good indicative of the potential adverse event.

In some implementations of the method, the pattern of motion indicative of active usage of the sporting good is identified at least in part based on a speed of the sporting good or an acceleration of the sporting good in at least one direction.

In some implementations, the method can include sending, by the processor, an opt out request to a user device in response to detection of the potential adverse event. The method can further include re-activating, by the processor, the activity monitoring application logic in response to reception of an opt out confirmation within a first threshold of time. The method can further include initiating, by the processor, an adverse event notification process in response to a failure to receive an opt out confirmation from the user device within a second threshold amount of time.

In some implementations of the method, the processing the second motion sensor data to identify the pattern of motion indicative of active usage includes identifying a pattern of motion indicative of a pedaling cadence on a bicycle.

In some implementations of the method, the pattern of motion indicative of the pedaling cadence includes at least one of an acceleration characteristic of a down stroke on a bicycle and an acceleration characteristic of a side-to-side motion of the bicycle.

In some implementations of the method, the processing the second motion sensor data to identify the pattern of motion indicative of active usage of the sporting good includes analyzing the motion data using a predictive model.

Another innovative aspect of the subject matter described in this disclosure can be implemented in a system including a memory and a processor coupled to the memory. The processor is configured to receive first motion sensor data of a motion sensor associated with a sporting good. The processor is further configured to, in response to the first motion sensor data, automatically activate an activity monitoring application logic. In the activity monitoring application logic the processor is further configured to receive a second motion sensor data of the motion sensor after the activity monitoring application logic is activated. Further in the activity monitoring application logic the processor is configured to process the second motion sensor data to identify a pattern of motion indicative of active usage of the sporting good. Further in the activity monitoring application logic the processor is configured to, in response to identification of the active usage, automatically activate adverse event detection logic. In the adverse event detection logic the processor is further configured to receive third motion sensor data of the motion sensor. Further in the adverse event detection logic the processor is configured to monitor the third motion sensor data to detect a potential adverse event experienced by the sporting good.

In some implementations, the system can include a user device configured to wirelessly communicate with the motion sensor. The activity monitoring application logic is activated only if the user device communicates with the motion sensor to indicate to the processor a proximity between the motion sensor and the user device.

In some implementations of the system, the user device is configured to receive the first motion sensor data, the second motion sensor data, and the third motion sensor data. The user device is further configured to send the first motion sensor data, the second motion sensor data, and the third motion sensor data to the processor.

In some implementations of the system, the processor is further configured to receive user motion data from the user device.

In some implementations of the system, the processor is further configured to automatically activate the activity monitoring application logic in response to the user motion data.

In some implementations of the system, the processor is further configured to automatically activate the adverse event detection logic in response to the user motion data.

In some implementations, the system can include a vehicle device configured to wirelessly communicate with the motion sensor. The activity monitoring application logic is not activated if the vehicle device communicates with the motion sensor to indicate to the processor a proximity between the motion sensor and the vehicle device.

In some implementations of the system, the processor is further configured to receive, from the vehicle device, vehicle location information. The processor is further configured to determine, based on the vehicle location information, a vehicle route. The processor is further configured to determine, based on the vehicle route, a potential hazard in the vehicle route.

In some implementations of the system, the processor is further configured to send to the vehicle device a potential hazard alert comprising a type and a location of the potential hazard.

Another innovative aspect of the subject matter described in this disclosure can be implemented in a non-transitory computer readable medium having instructions stored thereon that, upon execution by a computing device, cause the computing device to perform operations including receiving first motion sensor data of a motion sensor associated with a sporting good. The operations further include, in response to the first motion sensor data, automatically activating an activity monitoring application logic. The activity monitoring application logic includes receiving a second motion sensor data of the motion sensor after the activity monitoring application logic is activated. The activity monitoring application logic further includes processing the second motion sensor data to identify a pattern of motion indicative of active usage of the sporting good. The activity monitoring application logic further includes, in response to identifying the active usage, automatically activating adverse event detection logic. The adverse event detection logic includes receiving third motion sensor data of the motion sensor. The adverse event detection logic further includes monitoring the third motion sensor data to detect a potential adverse event experienced by the sporting good.

In some implementations of the non-transitory computer readable medium, the instructions further cause the computing device to perform operations including, in response to detecting the potential adverse event, sending an opt out request to a user device.

In some implementations of the non-transitory computer readable medium, the instructions further cause the computing device to perform operations including, receiving an opt out confirmation from the user device indicating a return to active usage of the sporting good. The instructions further cause the computing device to perform operations including, in response to receiving the opt out confirmation, re-activating the activity monitoring application logic.

In some implementations of the non-transitory computer readable medium, the instructions further cause the computing device to perform operations including, in response to a failure to receive an opt out confirmation from the user device within a threshold amount of time, initiating an adverse event notification process. The instructions further cause the computing device to perform operations including, in response to initiation of the adverse event notification process, sending an adverse event alert to a predetermined emergency contact.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

Some implementations will hereafter be described with reference to the accompanying drawings.

FIG. 1 shows an example of a person with a user device riding a bicycle with a sporting good device.

FIG. 2 shows an example of a bicycle with a user device and a sporting good device being transported on a car with a vehicle device and a user device.

FIG. 3 shows an example of an active usage orientation of a bicycle with a sporting good device.

FIG. 4 shows an example of an adverse event orientation of a bicycle with a motion sensor and a fallen user with a user device.

FIG. 5 shows an example of a snowboarder with a user device riding a snowboard with a sporting good device.

FIG. 6 shows an example of a skier with a user device riding at least one ski with a sporting good device.

FIG. 7 shows an example of a motorcyclist with a user device riding a motorcycle with a sporting good device.

FIG. 8 shows a user device, a server, a vehicle device, and a sporting good device that may be used in some of the implementations disclosed herein.

FIG. 9 shows an example flow diagram of a process for detecting an adverse event experienced by a sporting good.

FIG. 10 shows an example state diagram for automatic adverse event detection and alerting.

FIG. 11 shows an example state diagram for automatic driving or cycling detection.

FIG. 12 shows an example state diagram for automatic crash detection of a bicycle.

FIG. 13 shows an example graph of motion sensor data of a bicycle that is being transported.

FIG. 14 shows an example graph of motion sensor data of a bicycle that is being ridden.

FIG. 15 shows an example graph of motion sensor data of a bicycle that has experienced a sideways crash.

FIG. 16 shows an example graph of motion sensor data of a bicycle that has experienced an end-over-end crash.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways.

Described herein are various implementations for methods and systems for automatic adverse event detection and alerting. The implementations disclosed herein identify dangerous events and can alert emergency contacts such a relative, emergency medical services, police, etc. For example, activities where adverse event detection would be valuable include, without limitation, bicycling, skiing, snowboarding, skateboarding, roller skating, rock climbing, motor sports (e.g., all-terrain vehicles (ATVs), motorcycles, dirt bikes, snow-mobiles, jet skis), surfing, hang gliding, parasailing, hiking, walking, running, swimming, etc. An adverse event may, for example, be when a user of a sporting good associated with an activity crashes and injures himself or herself in such a way that he or she is unable to seek help for her injuries. The implementations disclosed herein are therefore valuable because the system may automatically detect such an adverse event and automatically alert any emergency contacts of the user.

In one example implementation, a sporting good device with motion sensors is attached to a sporting good. The motion sensor senses motion when the sporting good is moved and sends motion sensor data to a user device, such as a smart phone. The motion sensor data can be sent, for example, through Bluetooth™ or Bluetooth™ low energy (BLE) wireless protocol from the sporting good device to the user device. Upon receiving the motion sensor data, the user device initiates an activity monitoring application logic. In this way, the user device can detect when a sporting good moves, and can then begin monitoring data transmitted by the sporting good device to determine if movement of the sporting good is indicative of an active usage of the sporting good. In other words, after detecting an initial movement, the sporting good movement is further monitored to determine if a sporting good is being used (e.g., a bicycle being ridden or snowboard being ridden) or if the movement is not typical of an active use (e.g., bicycle being walked or transported, snowboard being carried). If the movement is typical of an active use, the system then activates an adverse event detection mode to monitor for adverse events such as a fall or crash.

One way in which an adverse event is detected according to an example implementation is by monitoring the orientation or change in orientation of the sporting good. For example, in a normal usage for riding a bicycle, a bicycle will generally stay upright with variances for pedaling, riding on hills, cornering, etc. If data from the motion sensor indicates a period of inactivity, the system examines orientation data preceding the inactivity. The system can determine if the orientation of the sporting good is an orientation that is more likely to occur in the case of an adverse event. For example, if a user is cycling, the bicycle laying down horizontally has an increased likelihood of being indicative of an adverse event. In another example, a snowboard being upside down is indicative of an adverse event. Change in orientation may also be examined by the system to determine an adverse event. For example, a change to a horizontal position of a bicycle occurring relatively slowly (e.g., someone laying down a bicycle in the field of a park) is not indicative of an adverse event, while a relatively quick change to a horizontal position of a bicycle may indicate an adverse event such as a crash.

Advantageously, the implementations disclosed herein can be activated and/or deactivated automatically so that the system is turned on and turned off without user interaction. Such implementations ensure that a user cannot forget to activate the system. Further, aspects of the system may be attached to the sporting good itself, such that after an initial installation, a user cannot forget to bring along a safety device used for the activity. Additionally, since aspects of the system turn on and off automatically, various aspects of the system are not unnecessarily left on, which helps preserve battery life of various devices disclosed herein. In other words, based on sensor data (accelerometer, global positioning system (GPS), etc.) of a motion sensor, user device(s), and/or vehicle devices, and/or presence of an NFC radio tag (e.g. an iBeacon™ transponder) (e.g., in the user and/or vehicle device), a model and/or heuristics can be built that very accurately determines when a user starts and stops an activity such as cycling. This can be done in a very power-efficient way (NFC tags may last for years, with minimal impact on a device's battery life) by using a motion sensor to wake the radio tag for proximity detection between a sporting good and a vehicle and/or user device.

In some implementations, models built by collecting a large dataset of various known activities can be used to predict an unknown activity or activity state. The model output can be combined with other heuristics into a state machine that can understand which activity the user is engaged in and uses that information to enable or disable the appropriate safety services at the appropriate time. Accordingly, the implementations disclosed herein can be used in a variety of sports, sporting goods, and activities to detect various types of adverse events accurately. In some other implementations, the devices used are activity specific and single activity models and heuristics are used to determine whether a given sporting good is in active use.

Advantageously, implementations disclosed herein also detect adverse events (e.g., falling or crashing events) robustly with high precision and recall. A system that generates false positives or misses events due to a criteria that is too specific will result in an increased chance of events being missed or the user abandoning the system due to distraction. Advantageously, some implementations disclosed herein are configured to detect actual adverse events that necessitate alerting an emergency contact with a high degree of precision with few, if any, false positives or negatives. In some implementations, this is achieved when the system determines that, even after a fall or crash, the user has not gotten back up and resumed their activity after a threshold period of time. For example, if someone crashes a bicycle, the system will monitor to determine if the bicycle returns to a normal active usage after the crash. If the user does so, an emergency procedure (such as an adverse event notification process) is not initiated. Even if a user is injured, the system can advantageously determine that at least the user is capable of seeking medical attention on his or her own because he or she has resumed active usage of a sporting good such as a bicycle.

An additional advantage of some implementations disclosed herein is the ability to determine whether a sporting good is in active usage or not. For example, if the system determines that a bicycle is being transported instead of ridden, the system may not monitor for potential adverse events. Such a configuration may preserve the battery of a user device and/or sporting good device with motion sensors because less monitoring of the active use of the device is done. Instead, the system may initiate other modes that use less energy and therefore lengthen battery life of devices. For example, a standby mode may be initiated to preserve battery life of various devices in the system. In another example, a potential hazard mode may be initiated to identify potential hazards on a route traveled by the user. The potential hazard mode can identify hazards associated with transporting a sporting good. A potential hazard mode may, in one implementation, only use GPS sensors to track a location of a sporting good device, user device or vehicle device. If a GPS signal from a vehicle device is used, significant battery saving may be realized in a user device and/or a sporting good/motion sensor device. For example, if the user is transporting a bicycle on the top of his or her car, the system may identify low clearance areas along a planned or expected route that may damage the bicycle.

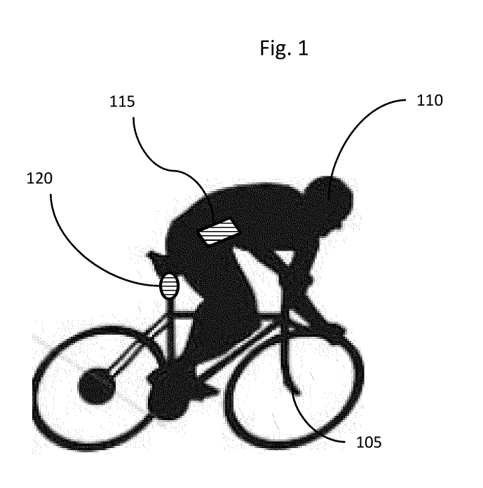

FIG. 1 shows an example of a person 110 with a user device 115 riding a bicycle 105 with a sporting good device 120 with a motion sensor. In alternative implementations, fewer, additional, and/or different components may be included. The user device 115 may be a smart phone or other device that is capable of short range communication with the sporting good device 120. The sporting good device 120 is located beneath the seat of the bicycle 105 and may include various motion sensors such as accelerometers, gyroscopes, global positioning system (GPS), MEMS sensors, force sensors, etc. In other implementations, the sporting good device 120 can be located elsewhere on the bicycle 105. In some implementations, the sporting good device 120 is removable from the bicycle 105, such that the motion sensor 120 may be used with other sporting goods. In other implementations, however, the sporting good device may be permanently or semi-permanently affixed to the bicycle 105. For example, the sporting good device 120 may be screwed or otherwise fastened to the bicycle. In another example, the sporting good device 120 may be inside the bicycle such as inside a hollow tube of the frame or seat of the bicycle 105.

The user device 115 can be a smart phone (e.g. iPhone™ or Android™ Phone). A smartphone can use its onboard sensors (e.g. accelerometer, GPS), other positioning technologies, and data network connection as disclosed herein. The sporting good device 120 may include a wireless transceiver with iBeacon™ capability. The transceiver may also communicate wirelessly with the smartphone via Bluetooth™ Low Energy (BLE) transponders to indicate proximity and exchange data as disclosed herein. Other short-range communication protocols that may be used for communication between the user device 115 and the sporting good device 120 include WiFi™, ZigBee™, ANT™, Bluetooth™ or Bluetooth Smart™ protocols. A processor of the sporting good device 120 may also process data from built-in motion sensors and transmit the results or raw data to the smart phone with the transceiver.

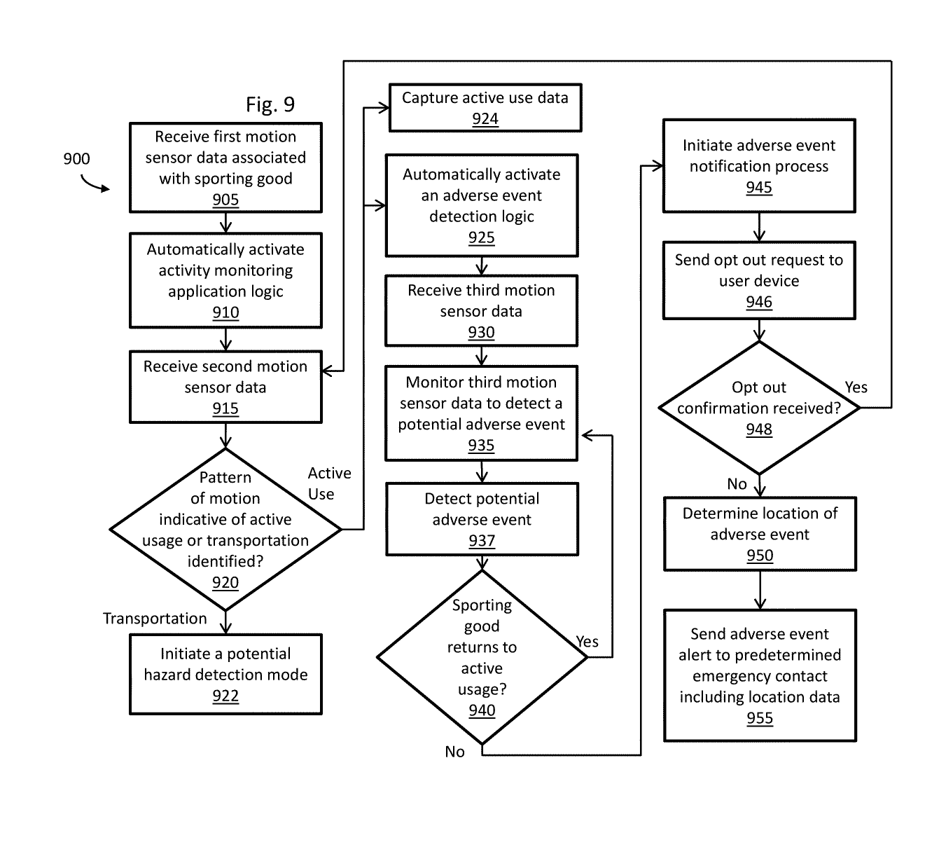

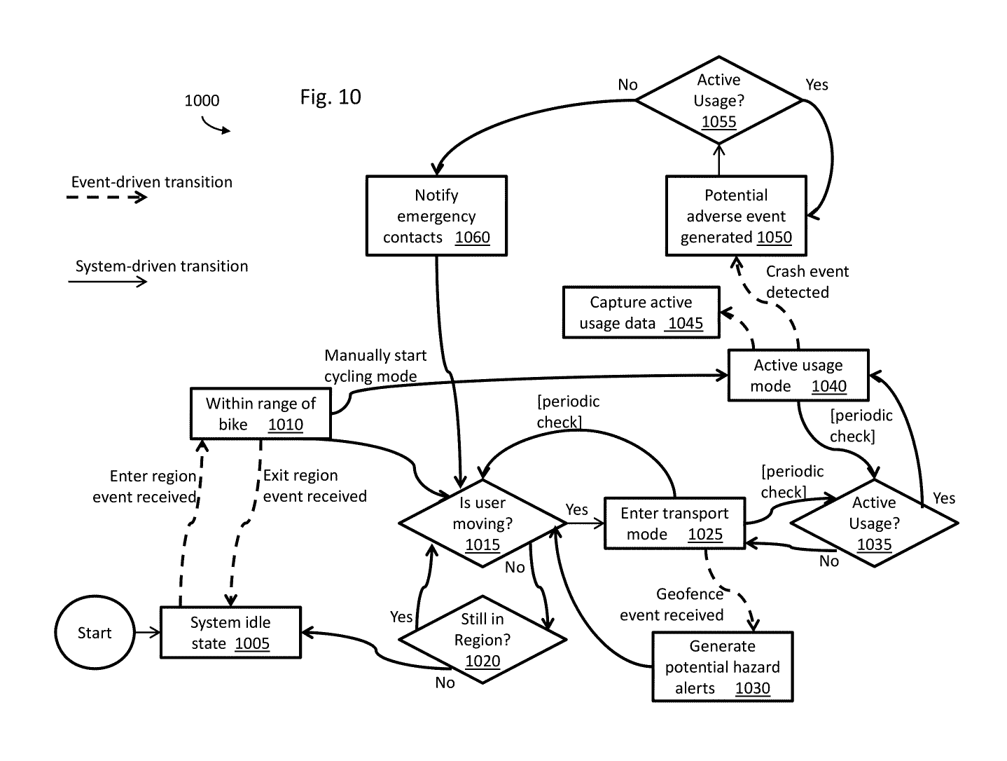

In one example implementation, a user has the user device 115, such as a smart phone, in his or her pocket (or mounted to their handlebars or carried in an arm band, etc.) that is capable of communicating with the sporting good device 120. The sporting good device 120 may include one or more of an accelerometer, a gyroscope, micro electromechanical semiconductor (MEMS) sensors, force sensors, global positioning system (GPS) sensors, heart rate sensor, temperature sensor, or a magnetometer. When the user comes into close proximity with the sporting good device 120 (e.g., within 0-50 feet), the sporting good device 120 and the user device 115 are capable of near field communication (NFC). When the user moves the bicycle 105 to unlock it, move it, or begin riding it, the sporting good device 120 detects the movement of the bicycle 105 using motion sensors and sends a signal indicating the movement (also referred to herein as first motion sensor data) to the user device 115. Upon receiving the motion sensor data, the user device 115 can detect whether the bicycle 105 is in active use, and further whether the bicycle undergoes any potential adverse events while the bicycle 105 is in active use as disclosed herein (e.g., discussion below with respect to FIG. 9).

In some implementations, the sporting good device 120 with motion sensors may be incorporated into the user device 115 or may otherwise may be attached to the user himself. For example, for activities such as hiking, swimming, or snowboarding, the motion sensor may be located on the user and the orientation, velocity, acceleration, etc. of the user himself is used to determine activity, potential adverse events, etc. For example, a motion sensor may be attached to sporting goods such as shoes, boots, clothing, goggles, helmets, etc. The motion sensors may be removable or permanently affixed to a sporting good. In another example, the user device 115, such as a smart phone, may itself include motion sensors and may function, either alone or in combination with an additional sporting good device, as the sporting good device for purposes of adverse event detection.

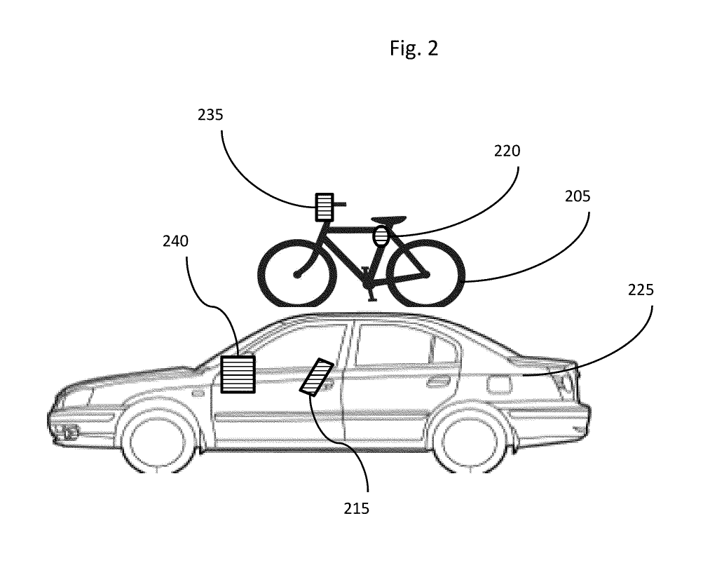

FIG. 2 shows an example of a bicycle 205 with a first user device 235 and a sporting good device 220 being transported on a car 225 with a vehicle device 240 and a second user device 215. In alternative implementations, fewer, additional, and/or different components may be included. The bicycle 205 is temporarily affixed to the top of the car 225. As disclosed herein, such a configuration can cause the system to operate in a transportation mode. Accordingly, safety alerts can be generated and sent to the first user device 235 and/or the second user device 215, such as an alert indicating a low clearance over a road that may damage the bicycle 205.

FIG. 2 also shows multiple user devices that may be used according to various implementations disclosed herein. For example, the second user device 215 shows an approximate location of where a user's smart phone may be located if he or she was operating or riding in the car 225. The first user device 235 shows an implementation of a bicycle computer. For example, some bicycle computers are used to track distance ridden on a bicycle, and may also be used as a user device as disclosed herein. The first user device 235 is attached to the bicycle 205, but may be a wearable device such as a watch, armband, heart rate monitor etc. Any of the first user device 235, the second user device 215, and the vehicle device 240 may communicate with the sporting good device 220 as disclosed herein.

The devices in FIG. 2 may be utilized in various ways. The vehicle device 240 may be equipped with GPS. Thus when the vehicle device 240 is sensed to be in close proximity with the second user device 215, the first user device 235, and/or the sporting good device 220, the GPS of the vehicle device 240 may be used in order to preserve the battery of the first and second user devices 215 and 235. In some implementations, the movement sensed by the sporting good device 220 may not indicate active usage of the sporting good, but may instead indicate that the sporting good is undergoing some other sort of movement of the sporting good, such as the sporting good being transported on the vehicle 225 as shown in FIG. 2. In such an implementation, the vehicle device 225 may wirelessly communicate with the sporting good device 220 to indicate a transportation mode, such that the activity monitoring application logic is not activated, because the vehicle device 240 and the sporting good device 220 communication indicates that a proximity between the sporting good device 220 and the vehicle device 240 is indicative of the transportation mode. In other words, the mere presence of the vehicle device 240 may indicate a high likelihood that the bicycle is being transported.

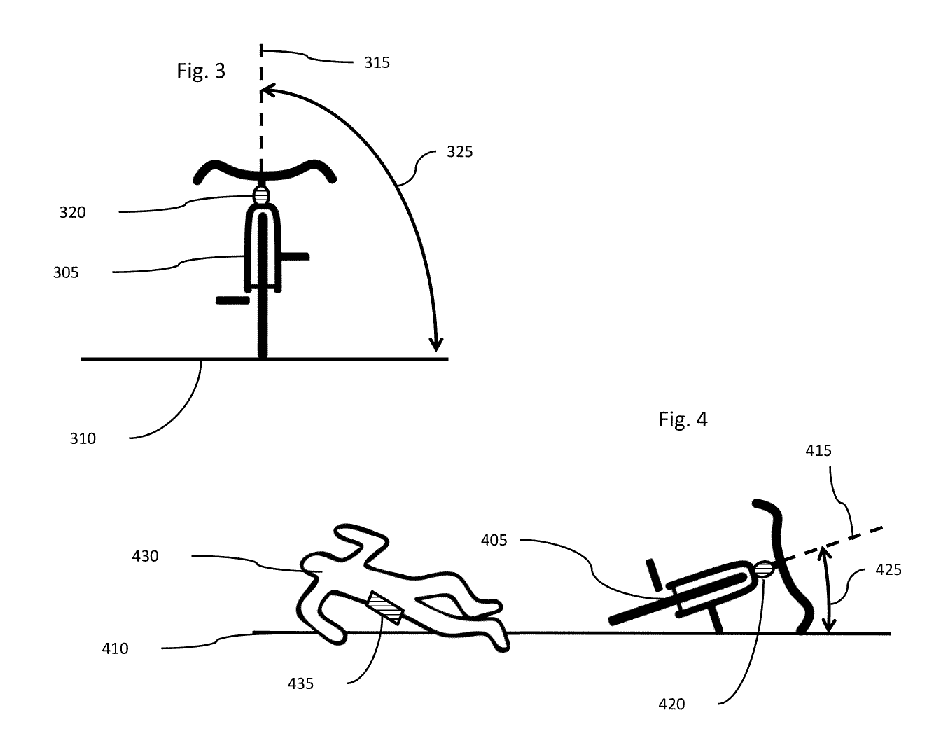

FIG. 3 shows an example of an active usage orientation of a bicycle 305 with a motion sensor 320. In alternative implementations, fewer, additional, and/or different components may be included. In some implementations as disclosed herein, orientation may be used to determine an activity state (active use, transportation mode, etc.) of a sporting good. FIG. 3 shows the bicycle 320 on a ground surface 310 aligned along an axis 315. An angle 325 between the ground 310 and the axis 315 is approximately ninety (90) degrees. This may be a typical mean angle of operation for a bicycle. Accordingly, the system detecting a substantial change in orientation from the operating orientation, may result in a determination of a potential adverse event. Although some changes in orientation of a sporting good may be typical for active use of a sporting good, other changes in orientation of a sporting good may be indicative of an adverse event. For example, a user riding a bicycle may experience normal changes in orientation when riding on a hill, cornering, from the cadence of pedaling, etc. However, changes in orientation may also indicate an adverse event, such as sudden change of more than 45 degrees. However, the thresholds for adverse events may be adjusted based on the sport and/or a particular user as well. For example, an expert snowboarder may perform tricks, like a front flip, that may result in orientations (snowboard being upside down) that are not typical for amateur riders. Similarly, advanced cyclists may take corners at higher speeds requiring greater banking of the bicycle. That is, some orientations may indicate an adverse event for some users while, without further context from other data, may not indicate an adverse event for other users. Accordingly, in some implementations, an application executing on the user device may include a user interface allowing a user to adjust the orientation sensitivity of the adverse detection logic used to detect a potential adverse event.

FIG. 4 shows an example of an adverse event orientation of a bicycle 405 with a motion sensor 420 and a fallen user 430 with a user device 435. In alternative implementations, fewer, additional, and/or different components may be included. The fallen user 430 with the user device 435 is on a ground surface 410. In some implementations, the system may detect an orientation or other motion sensor data associated with the user device 435 to indicate a potential adverse event. The motion sensor 420 can be used to determine an angle 425 between the ground surface 410 and an axis 415 of the bicycle 405. The angle 425 indicates that the bicycle 405 is likely laying on the ground, indicating a potential adverse event as disclosed herein.

In some implementations and as disclosed herein, a potential adverse event is detected by processing the third motion sensor data to obtain an orientation or a change in orientation of the sporting good, such as the bicycle 405, that is indicative of the potential adverse event. For example, if a user is bicycling, the system may detect a fall or crash by identifying a period of activity or active usage at some level of intensity, for example, via a measurement from an accelerometer of the motion sensor. The system may then identify a period of relative inactivity directly following the active usage period of activity. The system may then calculate the orientation change as an angle from a point in time before the inactivity was detected to a time just after the inactivity was first detected. For example, the system may determine that during the active usage prior to the inactivity, the bicycle 405 was being used relatively perpendicular to the ground at about ninety (90) degrees on average and did not exceed, for example, an orientation of less than sixty-five (65) degrees to the ground. From a time (e.g., 10 seconds) before the inactivity to a time after the inactivity was detected, the system may determine that the orientation of the bicycle changed about eighty (80) degrees to about an orientation of ten (10) degrees from the ground. The change in orientation may be compared to a threshold, (e.g., seventy-five (75) degrees). If the change exceeds the threshold, a fall (i.e., an adverse event) has been detected. If the orientation change exceeds the threshold, the system may determine whether the speed of the user goes to zero within a window that accounts for GPS latency and jitter (e.g. 10 s). Other thresholds may also be used such as 40, 45, 50, 55, 60, 65, 70, 80, or 85 degrees may be used depending on the traits of the user, the terrain, and the type of sport or activity. Further, the system may also examine absolute orientation instead of or in addition to change in orientation. Absolute orientation may be useful if a particular orientation is indicative of an adverse event. For example, if the bicycle 405 was upside down for any amount of time it may indicate an end-over-end crash.

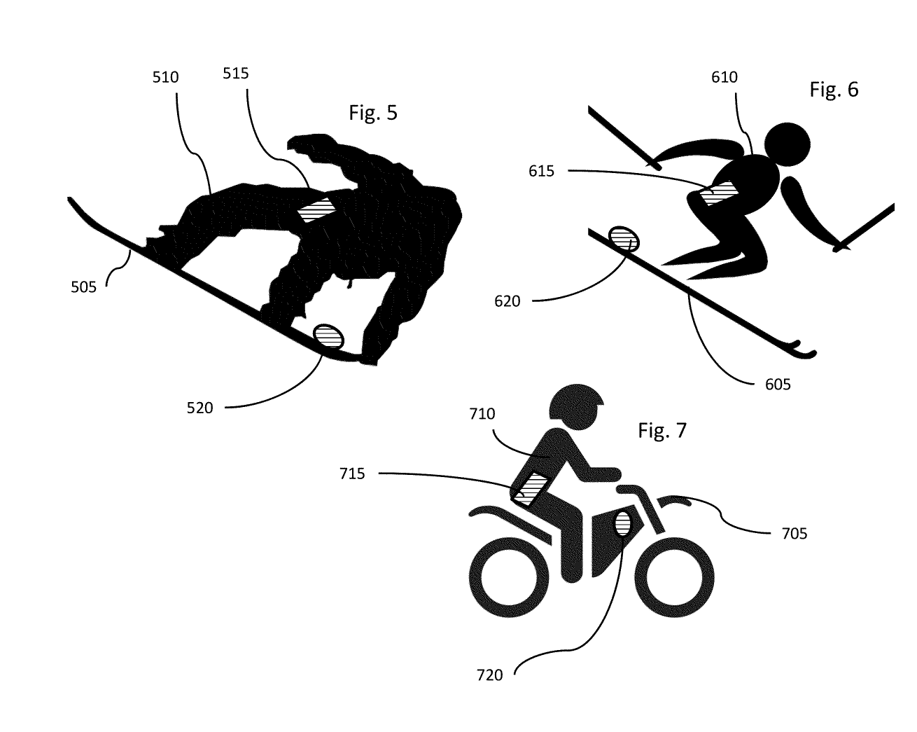

FIG. 5 shows an example of a snowboarder 510 with a user device 515 riding a snowboard 505 with a sporting good device 520. In alternative implementations, fewer, additional, and/or different components may be included. The user device 515 and the sporting good device 520 may be used as disclosed herein to determine adverse events experienced by the snowboarder 510 and the snowboard 505. As shown in FIG. 5, the sporting good device 520 can be attached to the top surface toward the rear of the snowboard 505. In other implementations, the sporting good device 520 may be attached to other parts of the snowboard 505, such as the bindings of the snowboard 505, toward the front of the snowboard 505, or on the snowboard 505 in between the bindings. The snowboard 505 can be manufactured with the sporting good device 520 embedded within the snowboard 505 itself. In other implementations, the sporting good device 520 may be worn on the snowboarder 510, such as on the snowboarder 510's boots, jacket, helmet, wrist etc.

The sporting good device 520 is used to detect an active use of the snowboard 505. For example, an active use can be detected by watching for a period of movement consistent with getting onto, riding, and getting off of a ski lift. Such movement would likely precede an active use of the snowboard 505. Such movement might be characterized by a prolonged period of time moving at a constant speed, a slight lateral sway indicating that the snowboard 505 is hanging by one boot of the snowboarder 510, etc. Movement directly associated with active use of the snowboard 505 can also be detected. For example, movement associated with downhill snowboarding may be detected. Since a snowboarder may lead with either end of the snowboard 505, such orientations can be associated with active use of the snowboard 505. In another example, movement associated with a periodic motion generated from a cutting action on each side of the snowboard 505 (which may be sensed independent of direction) may be used to identify active use. Snowboarders may also turn the snowboard 505 horizontally with reference to a downhill direction in order to slow down, so such an orientation and associated movement can also be indicative of an active use of a snowboard. In order to detect an adverse event experienced by the snowboarder 510, the sporting good device 520 can detect movement indicative of a crash or impact following movement indicative of active usage of the snowboard 505. An orientation of the snowboard 505 may also indicate an adverse event. For example, the snowboard 505 being upside down and not moving for a period of time can be indicative of an adverse event such as a crash. Other movements, accelerations, orders of different types of movements, orientations, changes in orientation, and/or inactivity of the snowboard 505 may all be used to determine whether a snowboard is in active use, being transported/carried, and/or experiencing an adverse event.

FIG. 6 shows an example of a skier 610 with a user device 615 riding at least one ski 605 with a sporting good device 620. In alternative implementations, fewer, additional, and/or different components may be included. The user device 615 and the sporting good device 620 may be used as disclosed herein to determine adverse events experienced by the skier 610 and the at least one ski 605. As shown in FIG. 6, the sporting good device 620 can be attached to the top surface toward the rear of one of the skis 605. In other implementations, the sporting good device 620 may be attached to other parts of the skis 605, such as one of the bindings and/or boots of the skis 605, or toward the front of the skis 605, or on one ski or the other. In another implementation, the sporting good device 620 can be attached to or integrated into a ski pole used by the skier 610. The skis 605 can also be manufactured with the sporting good device 620 embedded within one of the skis 605 itself. In another implementation, two sporting good devices can be used—one for each of the skis 605. In other implementations, the sporting good device 620 may be worn on the skier 610, such as on the skier 610's boots, jacket, helmet, wrist, etc.

The sporting good device 620 is used to detect an active use of the skis 605. For example, an active use can be detected by watching for a period of movement consistent with getting onto, riding, and getting off of a ski lift. Such movement would likely precede an active use of the skis 605. Such movement might be characterized by a prolonged period of time moving at a constant speed, some sway indicating swinging legs of the skier 610, etc. Movement directly associated with active use of the skis 605 can also be detected. For example, movement associated with downhill skiing may be detected. Since a skier generally skis with a proximate end of the skis pointed generally downhill, such an orientation of the skis 605 may indicate an active usage of the skis 605. Skiers may also perform some lateral movement with skis, such as lateral movement associated with a slalom-type action. Such movement also indicates a likely active use of the skis 605. In other words, movement associated with a periodic motion generated from a cutting action on each side of the skis 605 may be used to identify active use. In order to detect an adverse event experienced by the skis 605, the sporting good device 620 can detect movement indicative of a crash or impact following movement indicative of active usage of the skis 605. An orientation of the skis 605 may also indicate an adverse event. For example, the skis 605 being upside down and not moving for a period of time can be indicative of an adverse event such as a crash. In another example, if the skis 605 experiences a change in orientation consistent with the proximate (front) tip of the skis 605 turning from pointing downhill to turning uphill followed by a period of inactivity, such a pattern of movement indicates a higher likelihood of an adverse event. In another example, similar to monitoring of a bicycle, exceeding an orientation change may indicate a potential adverse event. In another example, if a ski is beyond an orientation threshold for, e.g., greater than five (5) seconds and there is no movement of the skis, the system may detect a potential adverse event. Other movements, accelerations, orders of different types of movements, orientations, changes in orientation, and/or inactivity of the skis 605 may all be used to determine whether skis are in active use, being transported/carried, and/or are experiencing an adverse event.

FIG. 7 shows an example of a motorcyclist 710 with a user device 715 riding a motorcycle 705 with a sporting good device 720. In alternative implementations, fewer, additional, and/or different components may be included. The user device 715 and the sporting good device 720 may be used as disclosed herein to determine adverse events experienced by the motorcyclist 710 and the motorcycle 705. As shown in FIG. 7, the sporting good device 720 can be attached to a body of the motorcycle 705. In other implementations, the sporting good device 720 may be attached to other parts of the motorcycle 705, such as a wheel, fork, handlebar, seat, hollow tube of the frame of the motorcycle 705, etc. The motorcycle 705 can also be manufactured with the sporting good device 720 embedded within the motorcycle 705 itself. In other implementations, the sporting good device 720 may be worn on the motorcyclist 710, such as on the motorcyclist 710's boots, jacket, helmet, wrist, etc.

The sporting good device 720 is used to detect an active use of the motorcycle 705. An active use of the motorcycle 705 may be detected by sensing a generally upright orientation of the motorcycle 705 and/or speeds consistent with the operation of a motorcycle. In contrast to sensing an active usage of a bicycle, the motorcycle would not demonstrate a pedaling cadence that may be present during active use of a bicycle. Another indicator of active use of a motorcycle is a slight reduction in acceleration when the motorcycle 705 is speeding up, indicating the changing of gears. Transportation and active use of the motorcycle 705 may happen at similar speeds. Accordingly, differentiation between transportation and active use may be indicated by greater side-to-side acceleration during active use, indicating leaning of the motorcycle 705 on turns that would not be present when transporting the motorcycle 705 on a trailer. Orientation and acceleration information indicating use of a kickstand may also be monitored to indicate an active use. For example, if the system senses movement and orientations consistent with the kick up of a kickstand subsequently followed by movement consistent with an active use, an active usage of the motorcycle 705 may be identified. If the sporting good device 720 is integrated into a motorized sporting good, such as the motorcycle 705, the sporting good device can be configured to detect when the motorized sporting good has been turned on. Sensing that a sporting good has been turned on is highly indicative of an active use of the sporting good. In order to detect an adverse event experienced by the motorcycle 705, similar methods as used to detect an adverse method for a bicycle may be used, such as those discussed above with respect to FIG. 4. Other movements, accelerations, orders of different types of movements, orientations, changes in orientation, and/or inactivity of the motorcycle 705 may all be used to determine whether a motorcycle is in active use, being transported, and/or are experiencing an adverse event.

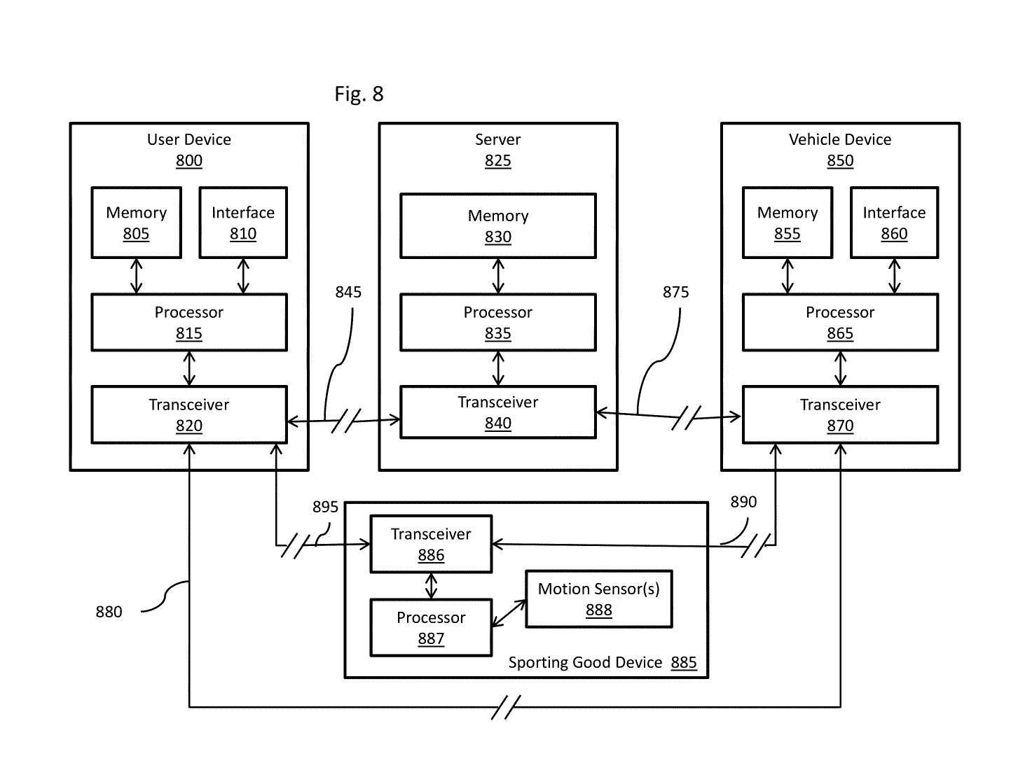

FIG. 8 shows an example block diagram 800 of a user device 800, a server 825, a vehicle device 850, and a sporting good device 885 that may be used in some of the implementations disclosed herein. In alternative implementations, fewer, additional, and/or different components may be included. In some implementations, the user device 800 may detect and adverse event and may send a message to the server 825 regarding the adverse event. The server 825 may then contact parties, such as emergency services about the adverse event. In another implementation, the user device 800 may download software (e.g., an app) from the server to execute the various methods and systems as disclosed herein. In another implementation, the user device 800 may send data, such as motion sensor data, to the server 825 for analysis. That is, the server 825 may act as processor for the user device 800 to preserve resources of the user device 800. In this way, the server 825 may determine potential and/or actual adverse events from the data received from the user device 800. In other implementations, the server 825 may collect data (with a user's permission) from the user device 800 in order to acquire more data points and information about normal uses of sporting goods as well as adverse events experienced by those sporting goods. In other words, the server 825 may collect data to inform models and calculations for future adverse event detection.

The user device 800 includes a processor 815 that is coupled to a memory 805. The processor 815 can store and recall data and applications in the memory 805. The processor 815 can execute sets of instructions stored on the memory. In one example, a set of instructions may be a mobile application (app). As used herein, the term app is a set of processor executable instructions stored on a memory and organized as a cohesive application or a portion thereof. The memory 805 may store more than one app. The processor 815 may also cause an interface 810, such as a display, to display objects, applications, data, etc., to a user. Input from the user, such as an adverse event notification opt out confirmation as discussed below, may be received through the interface 810. For example, the interface 810 may include a touch screen. The interface may also incorporate other hardware, such as a microphone, switches, buttons, etc., so that other inputs or voice commands may be received through the interface 810. The processor 815 is also coupled to one or more transceivers 820. With this configuration, the user device 800 can communicate with other devices, such as the server 825 through a connection 845, the vehicle device 850 through a connection 880, or the sporting good device 885 through a connection 895.

The server 825 includes a processor 835 that is coupled to a memory 830. The processor 835 can store and recall data and applications in the memory 830. The processor 835 is also coupled to a transceiver 840. With this configuration, the processor 835, and subsequently the server 825, can communicate with other devices, such as the user device 800 through the connection 845 or the vehicle device 850 through a connection 875.

The vehicle device 850 includes a processor 865 that is coupled to a memory 855. The processor 865 can store and recall data and applications in the memory 855. The processor 865 can execute sets of instructions stored on the memory 855. The processor 865 may also display objects, applications, data, etc. on an interface 860. The processor 865 is also coupled to a transceiver 870. With this configuration, the processor 865, and subsequently the vehicle device 850, can communicate with other devices, such as the server 825 through the connection 875, the user device 800 through the connection 880, or the sporting good device 885 through a connection 890.

The sporting good device 885 includes a processor 887 that is coupled to a transceiver 886 and motion sensor(s) 888. The processor 885 can transmit data, such as motion sensor data, through the transceiver 886 to, for example, the vehicle device 850 through the connection 890 and/or the user device 800 through the connection 895. In an alternative implementation, the sporting good device 885 may also include memory on which to store motion sensor data. Such memory may be used to house data such that the user device 800, for example, does not need to constantly monitor or communicate with the sporting good device 885. This can preserve battery life. Instead, the sporting good device 885 may periodically send motion sensor data to the user device 800. In another implementation, the user device 800 may transmit requests, on an as needed or periodic basis, motion sensor data or certain types of motion sensor data. The motion sensors 888 may include various sensors such as accelerometers, gyroscopes, a global positioning system (GPS), etc. The transceiver 886 may include or utilize various wireless communication protocols and associated hardware.

In some implementations, the user device 800 may be a smart phone, and the vehicle device 850 may be a computer integrated into a motor vehicle. The configuration of the user device 800, the server 825, and the vehicle device 850 is merely one physical system on which the disclosed implementations may be executed. Other configurations of the devices shown may be used to practice the disclosed implementations. Further, configurations of additional or fewer devices than the ones shown in FIG. 8 may be used to practice the disclosed implementations. Additionally, the devices shown in FIG. 8 may be combined to allow for fewer devices or separated where more than the four devices shown are employed in a system.

The devices shown in the illustrative implementations may be utilized in various ways. For example, the connections 845, 875, 880, 890, and 895 may be varied. one or more of the connections 845, 875, 880, 890, and 895 may be a hard wired connection. For example, if the sporting good device 885 and the user device 800 were integrated into a single device, the connection 895 may be hard wired. In other implementations, the connections 845, 875, 880, 890, and 895 may be wireless connections. Such a connection may take the form of any sort of wireless connection, including but not limited to Bluetooth™ connectivity such as Bluetooth™ low energy (BLE) like iBeacon™, Wi-Fi™ connectivity, or another wireless protocol. Other possible modes of wireless communication may include any type of near-field communications. Near-field communications may allow the various devices to communicate in short range when they are placed proximate to one another. Near field connection hardware and software may also be utilized by taking advantage of signal strength variances. For example, the closer the user device 800 is to the sporting good device 885, the stronger a near field communication signal may be. Such a function may be used as a data point for adverse event detection. For example, if the user has the user device 800 in his pocket while riding a bicycle with the sporting good device attached to it, the signal strength for the connection 895 may be relatively strong. If the user is hit by a car and is thrown from his bicycle, the signal strength for the connection 895 may be significantly weaker, indicating a possible adverse event. The signal may be weaker because the user device 800 is now further away from the sporting good device 885 than it was when the user was riding the bicycle normally. In yet another implementation, the devices may connect through an internet (or other network) connection. That is, the connections 845, 875, 880, 890, and 895 may represent several different computing devices and network components that allow the various devices to communicate through the internet, through various hard-wired or wireless connections. The connections 845, 875, 880, 890, and 895 may also be a combination of several modes of connection.

To operate different implementations of the system or programs disclosed herein, the various devices may communicate in different ways. For example, the user device 800 may download various software applications, such as an app for automatic adverse event detection and alerting, from the internet directly from an app provider or through an application store, such as the Apple™ app store or an Android™ app store. The vehicle device 850 may also be able to download apps. Such software applications may allow the various devices in FIG. 8 to perform some or all of the processes and functions described herein. Additionally, the implementations disclosed herein are not limited to being performed only on the devices in FIG. 8. Many various combinations of computing devices may execute the methods and systems disclosed herein. Examples of such computing devices may include desktop computers, cloud servers, smart phones, personal computers, servers, laptop computers, tablets, blackberries, Bluetooth™ enabled devices, wearable electronic devices, or any combinations of such devices or similar devices.

In one implementation, a download of a program to the user device 800 involves the processor 815 receiving data through the transceiver 820 through the internet and from the server 825. The processor 815 may store information (like the app for automatic adverse event detection and alerting) in the memory 805. The processor 815 can then execute the program at any time, including at a time specified by the user through the interface 810. The app may also operate in the background of the user device 800, waiting for detection of first motion data from the sporting good device 885 to wake it up and cause the app to operate actively on the user device 800 to perform the various methods, functions, and processes disclosed herein. In another implementation, some aspects of a program or app may not be downloaded. For example, the program or app may be an application that accesses additional data or resources located in the server 825. In another example, the program may be an internet-based application, where the program is executed by a web browser and stored almost exclusively in the server 825.

In yet another implementation, once downloaded to the user device 800, the program or app may operate in part without communication with the server 825. In this implementation, the user device 800 may access or communicate with the server 825 only when acquiring the program or sharing data through the connection 845. In other implementations, a constant or intermittent connection 845 may exist between the server 825 and the user device 800. Where an intermittent connection exists, the user device 800 may only need to communicate data to or receive data from the server 825 occasionally.

In some implementations, specialized hardware may be incorporated into the devices shown in FIG. 8 that is specifically designed to perform or execute the various implementations disclosed herein. For example, the devices may include near field communication (NFC) capabilities such as Bluetooth™ Low Energy (BLE) transponders like iBeacon™ devices or other similar devices. Additionally, the sporting good device 885 or any of the other devices may include motion sensing components such as accelerometers, gyroscopes, GPS capabilities, etc.

FIG. 9 shows an example flow diagram of a process 900 for detecting an adverse event experienced by a sporting good. In alternative implementations, fewer, additional, and/or different operations may be performed. Also, the use of a flow diagram is not meant to be limiting with respect to the order of operations performed. The process 900 includes operations of receiving first motion sensor data associated with a sporting good (operation 905), automatically activating an activity monitoring application logic (operation 910), receiving second motion sensor data (operation 915), and determining if the second motion sensor data indicates a pattern of motion typical of active usage or transportation of a sporting good (operation 920). If the motion is typical of transportation of a sporting good, the process 900 includes an operation of initiating a hazard detection mode (operation 922). If the motion is typical of active use of the sporting good, the process 900 includes operations of capturing active use data (operation 924) and automatically activating an adverse event detection logic (operation 925). The execution of the adverse detection logic (operation 925) includes operations of receiving third motion sensor data (operation 930), monitoring the third motion sensor data to detect a potential adverse event (operation 935), and actually detecting said potential adverse event (operation 937). After detecting the potential adverse event (operation 937), the process 900 includes an operation of determining whether the sporting good returns to active usage within a threshold amount of time (operation 940). If the sporting good does return to active usage, the process 900 returns to monitoring third motion sensor data for additional potential adverse events (operation 935). If the sporting good does not return to active usage within the threshold time, the process 900 initiates an adverse event notification process (operation 945). The adverse event notification process includes an operation of sending an opt out request to the user device (operation 946). If an opt out confirmation is received from the user, the process 900 returns to receiving second motion data to determine if the sporting good is being used again (operation 915). If an opt out confirmation is not received from the user, a location of the adverse event is determined (operation 950) and an adverse event alert is sent to predetermined emergency contacts (operation 955). In some implementations, in the case of an adverse event, the system may incorporate a live location broadcast of the user or user device.

In an operation 905, a first motion sensor data is received by a user device, such as the user device 800 as discussed above with respect to FIG. 8 from a motion sensor associated with and/or attached to a sporting good. The motion sensor can be incorporated, for example, into the sporting good device 885 shown in FIG. 8. The motion sensor data may be any type of motion data such as speed, velocity, acceleration, G force, change in location or orientation, etc. The motion sensor data may be received through various wireless protocols as discussed above with respect to FIG. 8.

In an operation 910, an activity monitoring application logic is automatically activated in response to the first motion sensor data. The first motion sensor data indicates that the sporting good has been moved, therefore the activity monitoring application logic is activated. The activity monitoring application logic is used to determine what type of activity the sporting good is engaged in. The activity monitoring logic can be incorporated into a software application stored in the memory 805 of the user device 800 shown in FIG. 8. The software application (app) may be active or it may be executing on the processor in the background. Upon receiving the first motion sensor data at a transceiver such as the transceiver 820 of FIG. 8 via an NFC signal such as Bluetooth™ low energy protocol, the app may be configured to react to the signal by becoming active and automatically executing an activity monitoring application logic. In other words, the activity monitoring application logic may be automatically activated based at least in part on a determination that the first motion sensor data indicates that the sporting good has moved. In some implementations, the activity monitoring application logic is activated only if the user device communicates with the sporting good device with a motion sensor to indicate to the system or app a proximity between the motion sensor and the user device. In other words, in some implementations, the motion sensor is not monitored unless it is in close proximity with the user device. In some implementations, the system may also consider motion data received from sensors in the user device to automatically activate the activity monitoring application logic.

In an operation 915, second motion sensor data is received by a transceiver of the user device, such as the transceiver 820 of FIG. 8. The second motion sensor data is monitored by the to determine patterns of motion indicative of certain types of use of the sporting good. In particular, the second motion sensor data is received as part of the execution of the activity monitoring application logic by the processor of the user device, such as the processor 815 of FIG. 8. In this example implementation, the second motion sensor data is defined as data received from the motion sensor after the activity monitoring application logic has been executed and is used to determine what type of activity the sporting good is undergoing. In this way, the app does not actively monitor motion sensor data until the activity monitoring application logic is activated, which can preserve battery life of the user device and/or the motion sensor.

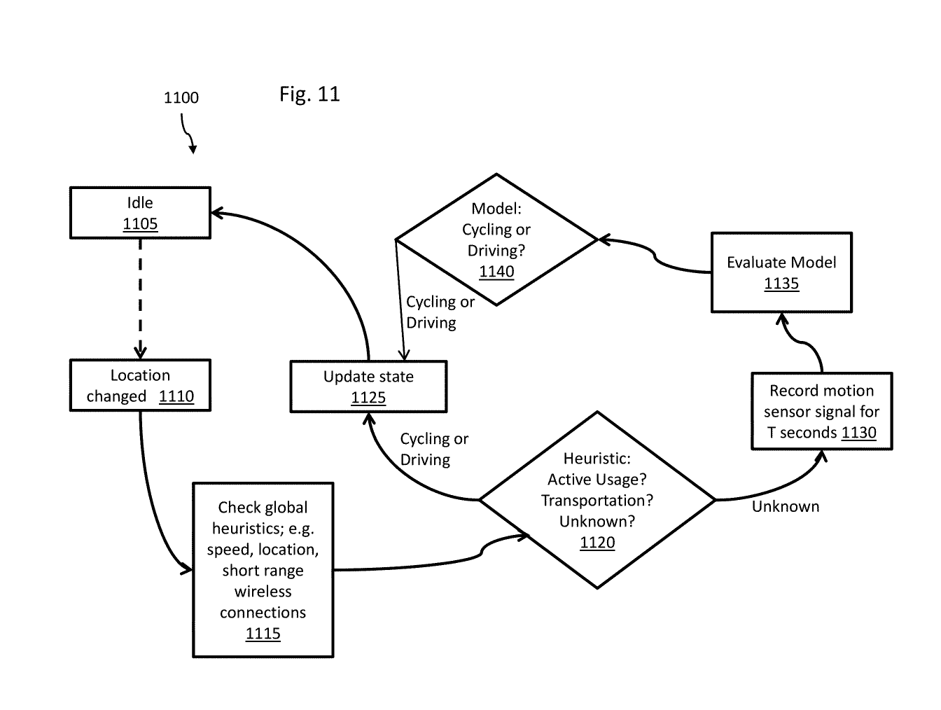

In an operation 920, a pattern of motion indicative of an active usage or transportation of the sporting good is identified. Data can indicate in various ways what type of activity is occurring. For example, if the sporting good is a bicycle that is travelling at 60 miles per hour, that would be indicative that the bicycle is being transported. If acceleration data of a bicycle has a pattern indicative of the cadence of pedaling, that would be indicative of active usage. The app on the user device (or a server in communication with the app on the user device) processes the second motion sensor data to identify a pattern of motion that is indicative of an active usage of the sporting good or a different pattern of motion, such as a transportation mode. If the app identifies that the sporting good is being actively used, the app can automatically activate an adverse event detection logic. For example, the app can cause the processor to begin executing computer executable instructions organized as a specific sub-routine for detecting adverse events. In some implementations, the pattern of motion indicative of active usage of the sporting good is identified at least in part based on a speed or velocity pattern of the sporting good or an acceleration of the sporting good in at least one direction. In some implementations, the system may also consider motion data received from sensors in the user device or other devices in communication with the user device (e.g., a cycling computer), to determine active usage of the sporting good. In some implementations, motion sensor data can be analyzed to extract features, which can be compared to predictive models that represent typical data for active usage of various sporting good activities and other predictive models that represent motion sensor data for adverse events. A model assembled from the actual motion sensor data can be evaluated by filtering and pre-processing the motion sensor data. Low-pass or high-pass filtering, decimation, normalization, etc may also be performed on the data. The system may then extract features, which may include min and max values, energy, frequency domain information, etc. to determine comparisons to known patterns for either active usage, transportation modes, and/or adverse events (as determined at the operation 937 discussed below). Feature extraction is further discussed below with respect to FIGS. 11, 13, and 14. The system can then evaluate the model, which may be a logistic regression, decision tree, random forest, HMM, SVM, etc. Based on the evaluation, the system can determine whether a sporting good is in active use or transportation mode at the operation 920.

In some implementations, other patterns of motion indicative of different uses than transportation or active usage may be identified. Such other uses or states of a sporting good may cause the system to monitor for potential adverse events other than a crash or fall. For example, GPS data along with orientation data of a bicycle may indicate that a user has ridden their bicycle to a coffee shop in town and parked their bike on or near a street. For example, the system can determine from the GPS location data that the bicycle is near a street and that this location is not the residence of the user (the residence of the user may have been input by the user when signing up for the service or may be recognized by the system as a frequent residential address that the bike is stored at for long periods of time). The system may further be able to determine from orientation data a characteristic lean of a bicycle when it is leaned up against a tree, wall, etc. or when it is parked using a kickstand. In another implementation with a motorcycle, a kickstand located under the motorcycle may also include significant accelerations that indicate the lifting a portion of the bike off the ground to prop it up on the kickstand and significant accelerations that occur when the motorcycle is set back down on the ground. In another implementation, characteristic accelerations and orientations common for storing skis and/or snowboards may be monitored. For example, at a ski resort, snowboarders and skiers often remove their skis and snowboards before entering a building, and prop them up at a stand for storing said skis and snowboards. The system may monitor motion sensor data to determine accelerations indicative of removing a ski or snowboard and then lifting them up to store in the rack. Orientation data may indicate the expected orientation of a ski or snowboard actually stored in the rack. This and other data may be used to determine that a sporting good is parked, and further may indicate that the sporting good is parked in a public location (as opposed to e.g., a private garage). When the system recognizes such a mode, it may subsequently monitor motion sensor data for adverse events such as motion indicative of the sporting good being stolen. For example, a pattern of use indicative of and prior to storing or parking a sporting good may also indicate what type of future use the system should expect to see when monitoring the sporting good. For example, if a user bikes to a coffee shop and parks his or her bicycle on or near the street, the system may be programmed to expect the next pattern of motion of the bicycle to indicate active usage as opposed to transportation of the bicycle. That is, it is unlikely for a user to ride their bicycle to a coffee shop then transport it back home. Accordingly, if the system did sense transportation of a bicycle after seeing it ridden to and parked at a coffee shop, an adverse event notification process, such as the one described below with respect to the operations 945, 946, 948, 950, and 955. A similar logic may be followed for other sporting good devices, such as when a snowboard or skis are stored at a ski lodge, for example.

If transportation movement is identified, a potential hazard detection mode may be initiated in an operation 922. In other words, the system may receive user motion data from the user device and activate the potential hazard detection mode in response to the user motion data. For example, if a user is hauling a trailer with one or more ATVs, the system may identify and instruct the user to avoid areas along a planned or expected route that may necessitate turning radii that are difficult or impossible for the user to navigate with the trailer loaded with ATVs. Some implementations may use external and crowd-sourced information to estimate in advance the such safety and/or convenience characteristics of a location or route, or to estimate the safety characteristics of a current or nearby location. The system may also, in response to identifying a potential hazard, suggest a different route for the user. In another example, if a hiking, running, or cycling route is known to have poor surface conditions, traffic, bad weather, etc, the system can provide this information to the user in advance. Such information can be informed by data gathered from other user's experiences in the location.

If an active use is identified, the system captures active use data of the sporting good at an operation 924. Such a step may capture information that may be of interest to the user, such as distance traveled, timing information, speed information, route travelled, etc. Such information can be tracked and stored for the user's convenience. In some implementations, information about active usage can be transmitted to the server and make available for viewing by third parties affiliated with the user, such as social network “friends” or “connections,” user-designated individuals, etc., to track progress of the user's activity. The information can be made available via a website, third-party user applications, social media services, etc. Information may be provided to the server in real-time, at designated intervals, or upon the user reaching designated locations. The system may also track mileage and routes that a sporting good traveled in an active usage state, and such information may be used to determine performance metrics for a user as captured by the various sensors and devices disclosed herein. The system may use such data to provide to the user device hydration and/or nutrition reminders to the user.

Additionally, in response to the active usage of the sporting good being identified, adverse event detection logic is automatically activated in an operation 925 by the processor of the user device, such as the processor 815 of FIG. 8. In other words, once the system determines that the sporting good is being actively used, the system activates the adverse event detection logic to begin watching for potential adverse events such as a crash or fall as indicated by motion sensor data received from a sporting good device, such as the sporting good device 885 of FIG. 8.

In an operation 930, third motion sensor data is received by the user device, such as the user device 800 of FIG. 8, from the motion sensor of a sporting good device, such as the sporting good device 885 of FIG. 8, during the adverse event detection logic. In this example implementation, the third motion sensor data is defined as any motion data received from the motion sensor after the adverse event detection logic is activated and is used to determine potential adverse events that the sporting good is undergoing. In this way, the system can avoid false crash or adverse event detections because the system will not monitor for adverse events unless the sporting good is being actively used.

In an operation 935, the third motion sensor data is monitored by a processor of the user device, such as the processor 815 of FIG. 8, and the third motion sensor data can be used to detect potential adverse events experienced by the sporting good. As disclosed herein, the system may monitor speed, location, acceleration, orientation, rate of change of orientation, periods of inactivity, etc. to detect potential adverse events.

In an operation 937, a potential adverse event is actually detected. As discussed, the potential adverse event may be detected based on various types of data from a sporting good device with motion sensors such as changes in velocity, acceleration, orientation, gravitational (G) forces, etc. on the sporting good as perceived by the motion sensor attached to and associated with the sporting good. For example, significant G forces may indicate an adverse event. In another example, a period of activity followed by a sudden period of inactivity may indicate an adverse event. In another example, an orientation of a sporting good that is atypical for an active use of that particular sporting good may indicate an adverse event. In another example, a change in orientation that is faster than typical could indicate an adverse event. Such examples may also be monitored in individually, or in various combinations, to provide a robust and accurate system for determining adverse events. For example, the system may watch for significant and sudden G forces along with a quick deceleration and a change in orientation followed by a period of inactivity to determine a potential adverse event has occurred. In some implementations, the system may also consider motion data received from sensors in the user device to determine a potential adverse event. In other words, the system may receive user motion data from the user device and motion data from the sporting good device to detect the potential adverse event. Such an implementation can expand the motion data that the system can examine to determine potential adverse events. Additional data from the user device may be useful because a characteristic adverse event may cause different movement to the user than to the sporting good itself. By considering additional motion data from the user device, a system could be more accurate. In other implementations, an impact (acceleration, velocity, or rotation event) can be sought at the time just preceding a detected period of inactivity (corresponding to the crash or adverse event) that exceeds a threshold (e.g. 4 g) above which normal events, such as laying a bike down after stopping, do not cause. Such information can be used to independently detect an adverse event or potential adverse event, or may be used in combination with the orientation and change in orientation data to detect an adverse event as discussed above. Utilizing more data in this way can yield a more robust adverse event detection system, reducing the instances of falsely detecting an adverse event. For example, in some implementations, an adverse event may be detected by a user device as follows: the user device determines an orientation based on at least linear accelerometer data from the motion sensor; the system estimates speed based at least on GPS data of the motion sensor or user device (e.g., the motion sensor 888 of FIG. 8); a signal energy detector of the user device determines a strength of signal between the user device and the linear accelerometers of the motion sensor; and detecting an adverse event such as a fall by identifying an orientation change that exceeds a first threshold, a decrease in signal energy greater than a second threshold, and a drop in speed below a third threshold. Such data (orientation change, signal energy drop, and speed drop) may also be detected to occur within a certain amount of time that is indicative of a fall or other adverse event. In another implementation an impact detector may also be used to detect an impact based on motion sensor data from the linear accelerometers. In such an implementation, the system may also identify an impact followed by an orientation change nearby in time to a decrease in signal energy and/or speed. In one example implementation, an inactivity is detected as a possible adverse event. Then, the orientation data may be analyzed to determine if the orientation or change in orientation meets a threshold indicating an adverse event. If it has not, it may indicate that the user has simply finished using the sporting good. Accordingly, the system may, in this case, initialize a standby or idle mode to save power and wait for a first motion sensor data to be received to indicate that the sporting good is again being moved to start the process 900 over again.

In an operation 940, the system determines if the sporting good has returned to active usage within a threshold amount of time. In other words, if there is a potential adverse event, the system, in the operation 940, determines if the user has resumed active use of the sporting good. Such a determination is made because, if a user experiences an adverse event but returns to active use with the sporting good, it is assumed that emergency services are not needed by the user. Accordingly, if the sporting good does return to active usage in the operation 940, the system goes back to monitoring the third motion sensor data with a processor such as the processor 815 of FIG. 8 to detect a subsequent potential adverse event at the operation 935.

If the sporting good does not return to active usage within the threshold time at the operation 940, the system initiates an adverse event notification process at an operation 945 executed by the processor of the user device, such as the processor 815 of FIG. 8. For example, if the system fails to detect a return to active usage of the sporting good (such as the bicycle) within a threshold amount of time (e.g., two minutes), the system may initiate an adverse event notification process. Such a process may cause the app to send an adverse event alert to a predetermined emergency contact or contacts. For example, if a user crashes her bicycle and does not get back on it and ride, emergency health services or other designated emergency contacts may be contacted with the adverse event alert as discussed below with respect to operation 955.

In an operation 946 and in response to detecting a potential adverse event, the processor, such as the processor 815 or the processor 835 of FIG. 8, sends out an opt out request to a user device or user device interface, such as the user device 800 and its associated interface 815 as shown in FIG. 8. An opt out request allows a user to input into the user device that there is not an adverse event that merits contacting an emergency contact. That is, the user can opt out of the system determining that an adverse event has occurred.

Accordingly, in an operation 948, the system either receives or does not receive an opt out confirmation from the user device, such as the user device 800 in FIG. 8, indicating a return to active usage of the sporting good. In response to receiving the opt out confirmation, the system resumes detecting motion data to determine if the user starts using, transporting, etc. the sporting good again (operation 915). If there is a failure to receive an opt out confirmation from the user device within a threshold of time, the system proceeds with the adverse notification process as disclosed herein.

In an operation 950, the system determines a location of the adverse event. For example, a GPS function of a user device may be utilized to determine a location of an accident.

In an operation 955, the system sends an adverse event alert from the user device, such as the user device 800 of FIG. 8, to predetermined emergency contacts, where the alert includes the location data. In some implementations, the adverse event alert may be routed to the predetermined emergency contacts through a server, such as the server 825 of FIG. 8. In some implementations, the server, such as the server 825, may determine that an adverse event has been experienced or otherwise receive an indication from the user device that the adverse event has been experienced. In such an implementation, the server may generate the adverse event alert and send it to the predetermined emergency contacts. In other implementations, the alert may include additional data about the user, the sporting good, the motion sensor data, etc. The adverse event alert may include various information, such as the location of the user device and/or motion sensor, the severity (based on the motion sensor data) of the adverse event, personal information about the user (e.g., name, age, weight, preexisting medical conditions and/or medical history), and information about the type of activity the user was engaged in (such as bicycling) when the user experienced the adverse event. In some implementations, the motion sensor is an activity specific device. Accordingly, if an adverse event alert is sent, the system will already know what type of activity the user was engaged in based on the type of device used. In some other implementations, the system may, as part of the activity monitoring application logic, determine based on the second motion data the type of activity the user is engaged in. This can be accomplished because different types of activities (e.g., snowboarding, bicycling, water skiing) have different characteristic patterns of motion indicative of active usage of each respective sport (and subsequent sporting good). The adverse event alert may be sent via Wifi™, Bluetooth™, short message service (SMS), e-mail, app notifications such as push notifications, a phone call, or any other type of electronic communication.

FIG. 10 shows an example state diagram 1000 for automatic adverse event detection and alerting. In alternative implementations, fewer, additional, and/or different operations may be performed. Also, the use of a state diagram is not meant to be limiting with respect to the order of operations performed.

In a system idle (or standby) state 1005, an app has been launched. For example, the app stored on the memory 805 of the user device 800 and may be launched by the processor 815 as shown in FIG. 8 and discussed above. The app can be in one of following states: 1) Operation in the foreground of a user device: the app is running in the foreground and available to respond to all events and types of motion sensor data. 2) Operation in the background of a user device: the app is running in the background and available to respond to key events including indications that a sporting good has moved: first motion sensor data (e.g., iBeacon™) and geofence events. In some implementations, a geofence refers to a potential route hazard along a likely or planned route of a sporting good that is either in active usage or being transported. For example, if a user is skiing, such as the skier 610 of FIG. 6, the system may determine that the skier is going toward a ski run that is closed. The system may identify the closed ski run as a geofence event, or a virtual geographic fence that the user should not cross in order to operate their sporting good safely. Therefore, geofence events may be triggered and sent to user even if a sporting good is in active usage. The system considers a potential hazard a geofence event because not every potential hazard is relevant to a user. That is, a hazard that is not along a planned or probable route of the user does not trigger a geofence event that notifies the user of the potential hazard. So, although numerous geofences or potential hazards may exist in a system memory, such as the memory 830 of the server 825 in FIG. 8, only geofences that are relevant to the user will trigger a geofence event as disclosed herein. In another example of a geofence event, the system may identify that, if transporting a bicycle such as the bicycle 205 of FIG. 2, certain height clearances of bridges, drive through, etc. may represent a hazard to safe transport of the bicycle. Accordingly, the system may recognize this virtual fence or geofence as an event that the user should avoid. Other geofences can include a location that has a deviation from an expected path (or detour), and/or a geo-fence defined by another user. The system may also provide to a user device a distance or estimated time to such dangerous locations from the current location. 3) The app is not running (but has not been killed by user): the app is not in a visible run state but is able to respond to first motion sensor data (e.g., iBeacon™) and geofence events. When an event is received, a local notification is generated that can be used to start the app. 4) The app has been actively killed by user and is not operating: if the app has been explicitly terminated, the app may be activated upon reception of the first motion data from a sporting good device. What constitutes killed by user may be platform-dependent; for example in iOS™ this means swiping the app from the switcher; for Android™, this would mean manually killing a service process.

When the user comes within some distance (e.g. 30 m, distance will vary based on local radio frequency (RF) conditions) of their bike, the sporting good device and the user device both have a transceiver capable of NFC communications like iBeacon™ (such as the transceivers 820 and 886 of FIG. 8), an entered region event (the entered region refers to the area in which the user device and the sporting good device are capable of communicating) will be generated and the system may advance to state 1010. Such an event is based on detection of the Bluetooth™ low energy (BLE) advertising packet sent by the transceiver of the sporting good device. Alternatively, the user can manually start a cycling session through an input, such as the interface 810 of FIG. 8, resulting in a transition directly to cycling mode at state 1040.

Otherwise, as long as the user device stays in range, the system advances to state 1015 to determine if the user is moving. While the transceiver of the sporting good device, such as the transceiver 886 of FIG. 8, is within range of the transceiver of the user device, such as the transceiver 820 of FIG. 8, or until an exit region event is generated, the app will enter a state to periodically assess if the user is moving generally, which could be any type of movement such as transportation or active usage. The moving assessment can be accomplished using a combination of location technologies, such as WiFi™, GPS and cellular radio. By combining these sources, movement thresholds can be evaluated on a mobile phone without compromising battery life as disclosed herein. For example, a system may use WiFi™ and cell radio to identify gross movements, and then use GPS to fine tune. Sampling GPS periodically (e.g. every 3 minutes) may also be used. Apple™ and Android™ smart phone operating systems can be used to deliver position updates at intervals such as 10 m, 100 m, 1000 m and 3000 m.

If the user device is not moving the system advances to a state 1020. There, the system determines if the user device is still within range of the sporting good device. If so, the system continues to watch for user device movement at the state 1015. If not, the system moves back to the system idle (standby) state 1005, which can preserve battery life of the user device and/or the sporting good device.

If it has been determined that the user device is moving and remains within the range of a near field communication (NFC) device (e.g., within an iBeacon™ region) (i.e. the user is moving with the bike), then the system proceeds to a state 1025 indicating a default transport mode (however the system will immediately begin to monitor to determine if the movement is actually cycling). The system can then determine if the user is transporting the bike or riding the bike at the state 1035. Accurately distinguishing between these two modes of movement will drive whether the system generates potential hazard alerts (such as a low-overhang warning) at a state 1030 based on geofence events or potential adverse events at a state 1050.

Distinguishing between driving vs. riding may include: 1) using other devices that are within range or connected (for example, users can tag certain Bluetooth™ devices as vehicle devices (e.g. audio Bluetooth™) or other user devices like bike computers such that the system recognizes whether certain devices are vehicle or bike devices (which can inform whether a user is cycling or transporting); 2) using speed data (e.g., speeds over 60 mph indicate driving); 3) using location data: off-road locations indicate cycling; 4) measuring orientation, change in orientation, acceleration, velocity, inactivity, etc. of a sporting good to indicate a particular activity, active usage of a sporting good, and/or type of sporting good. Also, an additional in-vehicle Bluetooth™ device may provide a dedicated potential hazard alert to the user when entering low-hanging danger zones at the state 1030. The presence of this vehicle device can serve as an indicator that the bike is being transported. Since the system can always generate a crash notification when the crash identification criteria is met and it is better to generate false positive low-overhang warnings vs. not generating any warning, the system will default to the transport mode at the state 1025. As discussed above, when the system is in transport mode at the state 1025 (default mode after movement is determined) and a geofence event is determined at the state 1030, a potential hazard alert is generated. Such a warning may be a visual and/or audio indicator on a user device such as the user device 800 of FIG. 8 and, if present, an alert on a second user device such as the user device 235 in FIG. 2 or a connected smart watch (e.g. Pebble™ LG™ G Watch™).

While in transport mode at the state 1025, the system will periodically check to determine if the sporting good such as a bicycle is still moving. If the movement is detected, then the system will periodically check to see if the sporting good is in an active usage at the state 1035, such as cycling. This check is useful when a user has initially transported their sporting good (e.g., bike) to a destination and then begins an active use of the sporting good (e.g., riding the bike). Checking for active usage should be frequent enough as to not miss much of the start of active usage and therefore discount the capture of active usage data (e.g. time, distance). In some implementations, active usage data can also be used to determine service/maintenance reminders, which are further discussed below. Detecting the difference between active usage such as cycling and transport modes such as driving is discussed throughout including below with respect to FIG. 11.

Once in active usage mode at the state 1040, the system can begin to automatically capture active usage data at the state 1045, such as time of active use, distance covered, average speed, etc. In this state, the system may enter into a high resolution GPS capture state for accurate miles and routing information. Such metrics can be fed into an automated service reminder/recommendation feature, as discussed below in greater detail.

In some implementations, the systems and methods disclose herein may also provide various safety services such as the service reminder/recommendation feature. The maintenance reminders cab be generated based on collected active usage data, such as time, duration, wear factors, terrain, temperature, humidity, etc., which can all be used to recommend maintenance. The system may compare such usage characteristics to a database of service rules to output to the user device service recommendations. The system may take into account a model, age, wear state, and similar information about a sporting good in order to make such service recommendations.

By automatically tracking bike usage as disclosed herein, a recommender algorithm based on heuristics and riding data can systematically provide recommendations to the user/rider on what maintenance to perform on the bike and when. For cycling examples, the recommendations may be based one or more of: 1) riding type—off road, on road, bmx, cyclo-cross, etc.; 2) bike type—road, mountain bike, hybrid, cyclo-cross, etc.; 3) component type—the make, model and year of the component; 4) end of life or maintenance interval time—the elapsed time to replace, service, or assess the component or part; 5) utilization—how the part has been used (variables include time, distance or other part specific metrics such as revolutions, turns, etc.); 6) user preferences—user inputs that change the behavior of the recommender algorithm (e.g. frequency of recommendations, suppressing of recommendations, etc.); 7) user overrides—user-defined rules that override end of life or maintenance interval times; 8) sensor data—data from devices (such as phones, GPS recorders, heart rate monitors, cadence sensors, etc.). The recommendation system may output recommendations to a user device such as the user device 800 of FIG. 8. The recommendations can be one or more of: 1) perform service—service a component or part (e.g. grease bottom bracket); 2) replace part—replace an existing component (e.g. replace a worn chain); 3) upgrade a part—replace a part with a higher quality part; 4) inspect part—perform an inspection of a part (e.g. check if wheel is true). The recommendation service may also provide recommendations on where to purchase parts and services. Such recommendations may be based on one or more the following inputs: 1) price: the cost of the part; 2) availability: whether or not the part is in stock; 3) proximity—how close the part is to the user's preferred location; 4) previous purchase history: past purchase transaction; 5) preferences: user inputs that change the behavior of the recommender (e.g. price ranges, brand exclusions, etc.); 6) fulfillment time: total time to expected receipt of the part.

While in active use mode, the system may detect potential adverse events to advance to state 1050. The potential adverse events may be detected in various ways from motion sensor data of the sporting good device as discussed above. For example, a potential adverse event may be detected as any acceleration that exceeds a certain threshold, an particular orientation or change in orientation, a period of inactivity, and/or by a combination of motion and location data.

Immediately after detecting a potential adverse event, the system checks to see if the sporting good is still in active usage for a threshold time (e.g. 15-30) seconds at a state 1055. If it is determined that the sporting good is still in active usage then the potential adverse event is discarded and the system can return to the state 1050 to monitor for future potential adverse events. After a potential adverse event is detected, a user-defined countdown begins during which time the user can dismiss the crash alert (an opt out). If not dismissed, the user's emergency contact(s) are notified at a state 1060.

FIG. 11 shows an example state diagram 1100 for automatic driving or cycling detection. In alternative implementations, fewer, additional, and/or different operations may be performed. Also, the use of a state diagram is not meant to be limiting with respect to the order of operations performed. The state diagram 1100 details the automatic detection of either an active usage or a transportation mode of a sporting good. Such a determination can be made based on a variety of sensed and wireless factors, allowing the system to automatically activate features to track a user and activate various safety features in a power efficient manner and utilizing little to no active user interaction.

When the system does not detect motion, a sporting good device, such as the sporting good device 885 of FIG. 8, will be idle (standby) at a state 1105. Based on GPS, WiFi™, cellular radio or other communication protocols, the mobile operating system of a user device can detect a location change of a sporting good at a state 1110. The location change threshold may be configured to a threshold such as 1 m, 10 m, 100 m, or 1000 m. This threshold may be configurable by the user as a trade-off between distance accuracy and battery consumption. Motion sensor data, such as accelerometer data and/or orientation data, from the sporting good device may be used to identify inactivity (such as when a bicycle is stored in a garage). Inactivity vs. some motion may bound motion detection. A timeout threshold may also be established to determine that a sporting good is no longer moving at all and can reset to the idle (standby) state 1105.

Once movement is detected at the state 1110, a first set of indicators may be consulted to attempt to detect active usage or a transportation mode at a state 1115. Such indicators may include: 1) presence of a vehicle device such as Bluetooth™ devices that indicate driving (e.g., car audio Bluetooth™); 2) presence of Bluetooth™ devices that indicate cycling (e.g. bike computer, heart rate monitor); 3) speed of movement; 4) location (e.g. on road or off road, on highway or on side road); 5) proximity of the sporting good device to the user device; 6) inactivity of the sporting good. A global heuristic rule can evaluate the indicators above to determine if the sporting good is in active usage, being transported, or if more information is needed at a state 1120. Alternately, a stochastic model can be created to combine the indicators and predict the state.

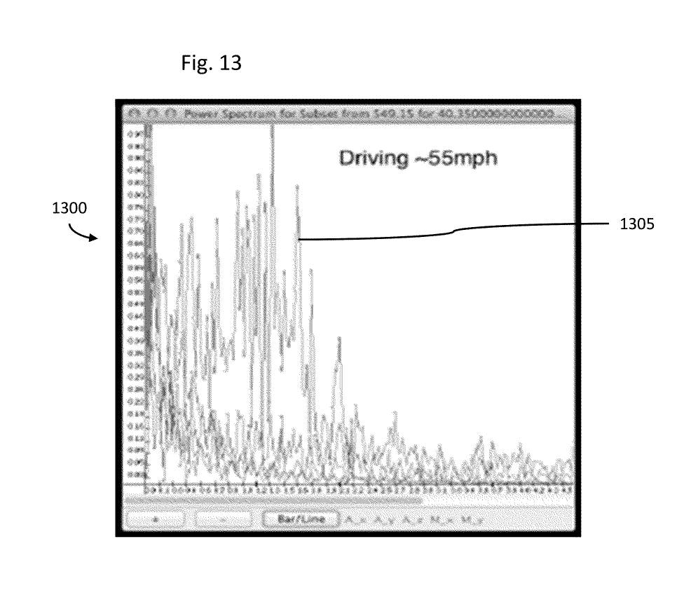

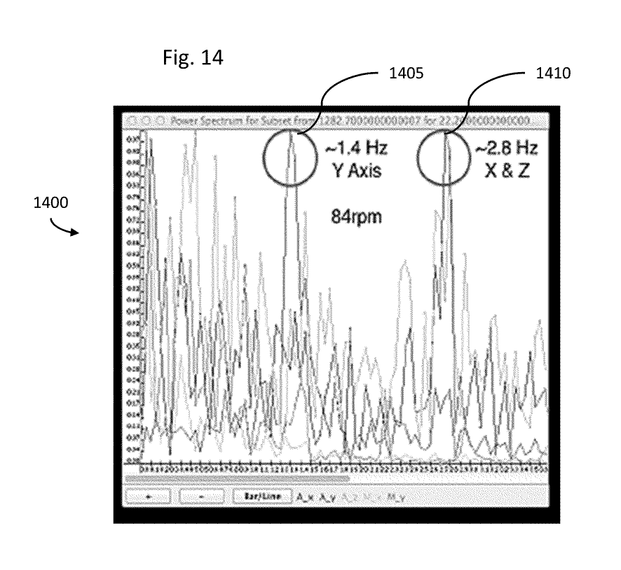

Once driving or cycling is known, the state of the system is recorded at a state 1125 and the system returns to idle until the next location change. If the heuristics fail to distinguish between driving and cycling, motion sensors (e.g. accelerometers, gyroscopes, magnetometers, etc.) can be used at a state 1130 to indicate factors such as orientation and/or change in orientation, acceleration, velocity, etc. of the sporting good. For example, a window of sensor data (e.g. 20 seconds) can be recorded at some sample rate (e.g. 100 Hertz (Hz)). The data can be recorded on a user device such as a mobile phone or on a sporting good device affixed to the bike. The sensor data can then be analyzed to extract features, which can be used to evaluate a predictive model at a state 1135. A model may be evaluated by filtering and pre-processing the data. Low-pass or high-pass filtering, decimation, normalization, etc. may also be performed on the data. The system may then extract features, which may include min and max values, energy, frequency domain information, comparisons to known patterns, etc. Feature extraction is further discussed below with respect to FIGS. 13 and 14. The system then evaluates the model, which may be a logistic regression, decision tree, random forest, HMM, SVM, etc. Based on the evaluation, the system can determine whether the sporting good is in an active use or a transportation mode at a state 1140 of FIG. 11. Additionally, similar feature extraction techniques may be used to detect adverse events as discussed below.

The results of the model can be used to update the system state at the state 1125 of FIG. 11. The model (or a different model) can also predict activity states other than active use vs. transportation mode. For example, a model can predict road vs. off-road cycling, walking (with the bike), seated vs. standing cycling, as well as all different types of varying sporting goods and their respective possible uses.

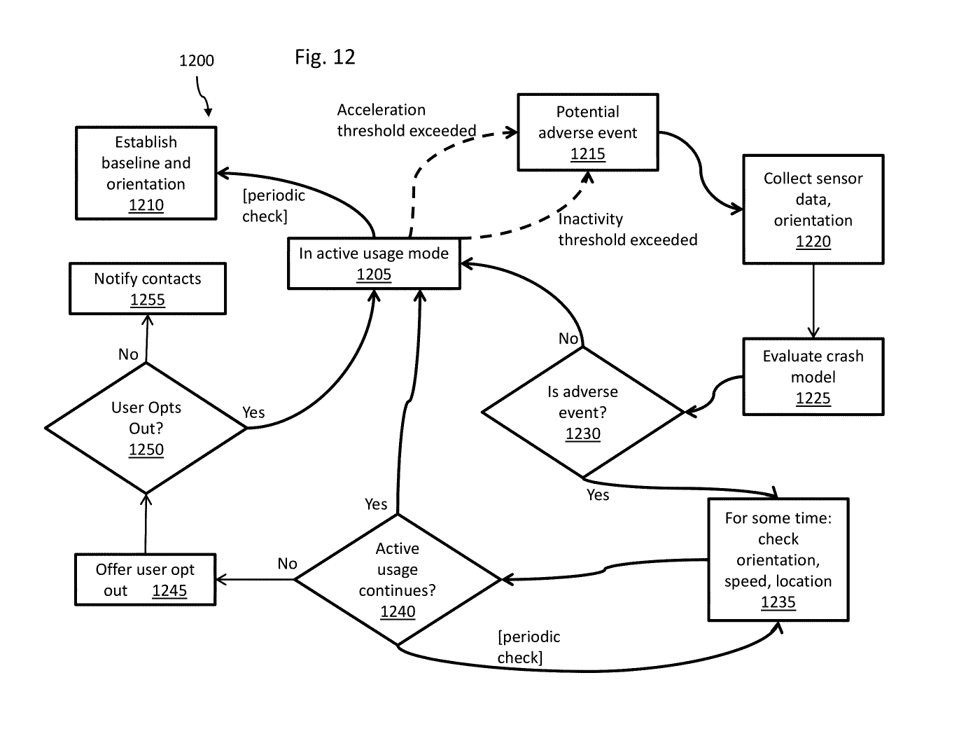

FIG. 12 shows an example state diagram 1200 for automatic crash detection of a bicycle. In alternative implementations, fewer, additional, and/or different operations may be performed. Also, the use of a state diagram is not meant to be limiting with respect to the order of operations performed. The state diagram 1200 describes the states for detection an adverse event such as a crash or fall on a bicycle. Adverse event detection is active in an active usage mode at a state 1205, which is detected automatically (or can be a manual user action to enter).

At a state 1210, periodically (e.g., every 3 min, every 1000 m location change) during active usage, motion sensor data from the user device (e.g., the user device 800 of FIG. 8) or sporting good device (e.g., the sporting good device 885 of FIG. 8) may be inspected to determine sporting good device orientation and a movement baseline. A sporting good's orientation is automatically determined by the sporting good device, which allows the user to install the sporting good device onto the bike in whatever orientation is convenient. Such an orientation will be considered to indicate a bike, for example, is in an upright and ride-able state. Movement baseline is determined using motion sensor data from the sporting good device to extract a data baseline for the active usage such as a bike ride. This can include measuring noise or energy, minimums and maximums, or other factors of the motion sensor data. This baseline may be used to tune a crash model based on the riding style of a particular user and conditions (e.g. road or off road) of a particular route, road, weather, etc.

Based on one of several triggers, the system may perceive a potential adverse event at a state 1215. This potential adverse event will be evaluated further to determine whether it is genuinely an adverse event such as a crash or whether it is a false positive. Triggers may include an acceleration event and/or a period of unexpected activity. An acceleration event as recorded by the sporting good device or the user device may exceed a threshold (e.g. 5 g's) in any or some specific axis to indicate a crash. Alternatively, it can also be defined by a more sophisticated signature of motion sensor data evaluated by heuristics or a model. A period of unexpected inactivity may be used to determine a potential adverse event with or without detecting an acceleration event. For example, in the case that a crash occurs without triggering an acceleration event, it may still be detected based on a lack of movement in the sporting good device and/or the user device.

Once a potential adverse event is identified, further motion sensor data is received for analysis at a state 1220. This data may represent motion sensor data from the sporting good device that precedes and/or follows the potential adverse event in time. This data may come from the sporting good device or the user device, and may include orientation and other movement features to compare to the baseline established at the state 1210. At a state 1225, the sensor data collection will then be pre-processed and filtered and features will be extracted and evaluated using a stochastic model trained on example data previously collected. This may be done in a method similar to that discussed above with respect to the state 1120 of FIG. 11.

The result of the model evaluation can be the probability that the sensor data indicates a crash or not. The model may combine features from the user device and sporting good device and may include rule-based or heuristic aspects in addition to a purely statistical/machine learning approach. In other words, the system can compare data of the potential adverse event to the established baselines to determine probability for an adverse event, and can use rule based decisions (e.g., is user device motionless after a period of active usage). At a state 1230, if at this point the probability of a crash is below some threshold (e.g. p=0.25), the potential adverse event will be abandoned and the system will return to the active usage state 1205. If the potential adverse event appears to be an actual adverse event, the system will attempt to determine if the user resumes active usage at a state 1235 (based on the logic that if s/he does so, responder notification is not needed). This check may evaluate one or more of the following: 1) orientation: does the user return the bike to the known upright orientation? or is it left lying down? 2) speed/location: does the user begin moving again at a speed that indicates cycling? Such checks can be performed periodically for some time period (e.g. 3 min) If no movement or upright transition is detected within this window, the system will conclude that the user has experienced an adverse event. If active usage does resume as indicated, for example, by movement and an upright orientation at a state 1240, the system will return to the active use state 1205. If the system determines at the state 1240 that an adverse event has occurred, the system will offer the user the opportunity to opt out of adverse alert notification at a state 1245. This opt-out can be time limited—if some amount of time (e.g. 1 min) passes without the user opting-out, the system will notify emergency contacts and/or emergency responders at a state 1255. If the user does opt-out, the system will return to the active usage mode 1205.

Power spectrum of accelerometer data shows strong frequency components in cycling data that correspond to pedal cadence. These frequency components are not present in driving data. Extraction of this frequency power info can be the basis for a predictive model for cycling vs driving. FIG. 13 shows an example graph 1300 of motion sensor data of a bicycle that is being transported. FIG. 14 shows an example graph 1400 of motion sensor data of a bicycle that is being ridden. Line 1305 shows power spectrum of z axis accelerometer data that is much higher than the power spectrum of x and y axis accelerometer data, indicating driving rather than cycling. This z axis acceleration is related to the forward motion of the car transporting the sporting good: slowing down and speeding up while driving, while vertical (x-axis) and side-to-side (y-axis) acceleration of a transported sporting good is significantly lower than the variations in forward and backward (z-axis) acceleration. In other words when driving (transporting a sporting good), the most pronounced accelerations are forward/backwards. Side to side and up/down accelerations are limited/dampened by tires, shocks, springs, and limits to how hard a car can corner. In FIG. 14, peak 1405 corresponds with power spectrum of y axis accelerometer data, while peak 1410 corresponds with power spectrum of x and z axis accelerometer data, indicating road cycling motion. In particular, the side-to-side (y-axis) acceleration peak alternates with the vertical (x-axis) and forward/backward (z-axis) accelerations. This occurs because when a down stroke of a pedal occurs, the bicycle accelerates forward (z-axis) and moves downward due to the downward pedal stroke (x-axis). In contrast, a bicycle experiences relatively more side-to-side (y-axis) acceleration in between pedal strokes. In other words, when cycling, there is more power in all three axes as compared to the driving/transporting mode described with respect to FIG. 13 above. While cycling, there are noticeable peaks that correspond to the side to side motion of pedaling (1405) and the forward impulse generated by each pedal down stroke (1410). In particular, the side-to-side (y-axis) peak generally occurs at half the frequency of the up-down and forward-backward acceleration (x and z axes, respectively). This occurs because the side-to-side motion encompasses a complete rotation of the pedals at the first frequency (the cyclists cadence). Within that rotation, there are two down strokes of the pedal, one for the left and one for the right. While there can be power generated throughout the entire pedal stroke, the downstroke carries the most. As such, each downstroke causes the bike to surge (accelerate) forward. Since there are two downstrokes per cadence cycle, the forward-backwards frequency is twice the cadence frequency. The x-axis (up/down) acceleration may come from either the bicycle frame and tires flexing, or from the sensor not being perfectly aligned to the bike such that the forward-backwards acceleration is spread across X and Z. Accordingly, extraction of various motion sensor data can be performed to determine a type of activity (e.g., cycling), whether the sporting good is in an active usage mode, and whether a sporting good experiences a potential adverse event.

For example, active use data and other information may be determined from the sensors disclosed herein by extracting peaks from motion sensor data. A method for determining if the user is riding (vs. transporting the bike) looks for a periodic signal coming from the accelerometer from either the motion sensor or the user device. Such a signal is based on data such as (a) the side-to-side motion of the bike and/or (b) the forward accelerations of the bike both of which are a result of the rider applying greater force to certain regions (e.g. the down stroke) of the pedal stroke. This signal contains the following information: 1) cadence: the number of pedal strokes per unit of time (e.g. minute); 2) pedaling effort: the amplitude of the signal indicates how far the bike is moving side-to-side and represents the relative power of each stroke. Given this, a nominal scale can be used where the range of the scale is based on the average amplitude of the signal over time. For example: 1) easy/recovery: 0.5 g-0.75 g; 2) moderate: 0.76 g-1.25 g; 3) hard: 1.26-2.5 g; 4) very hard: >2.6 g. Further the system can use this information to provide feedback to the user when the user should shift. Based on (a) a user-entered cadence preference or (b) the system learning over time what the user's preferred cadence range is, the system can identify when the user should shift to a higher gear (when the cadence is greater than the preferred range) or shift to a lower gear (when the cadence is lower than the preferred range).

A model used for determining a use mode for a sporting good may be built in various ways using different types of data. For example, a model to predict either an active use mode such as cycling or a transportation mode such as driving can be built using features extracted from motion sensor data (e.g., accelerometer), GPS location data, and/or the presence of certain wireless devices. In some implementations, the system may analyze groups of data by sectioning raw time series data into sections of data of a specific duration, such as 5 seconds. Then, for each 5 second section of data, the system can extract a set of features that are descriptive of the data. One example set of features that can be extracted include could include: 1) a maximum absolute value of accelerometer data in each of X, Y, and Z axes during the section of data; 2) a standard deviation of Z axis accelerometer values (where Z is the vertical axis); 3) an average GPS speed during the during the section of data; 4) a Boolean value indicating whether a bike-specific wireless devices (such as a bike computer) are present; 5): a boolean value indicating whether car-specific wireless devices (such as the car itself or navigation system of a car) are present; 6) a dominant frequency on the vertical (Z) axis of the accelerometer data, as extracted from a power spectrum, such as discussed above with respect FIGS. 13 and 14. Dominant in this implementation can be defined as a peak in the frequency domain more than some factor taller than any other, within some expected range of frequencies, such as 50-150 Hertz (Hz). A value of 0 may indicate a lack of a dominant frequency component. Other features may also be useful, such as forward-backward and side-to-side frequency data, other statistics computed on time-series accelerometer data, and/or data pulled from external geographic information system (GIS) sources (such as whether the bike's location is on a road or not). To create the model, a training dataset can be compiled containing, for example, 1000 hours of cycling and 1000 hours of driving data. The data collected can be more valuable and robust if it includes sample data from a range of cyclist types, bicycle types and sizes, vehicle types, surface conditions, etc. The training dataset can then be used to build the model. In one implementation, a decision tree or heuristic may be used to compare actual use data from motion sensors to the model data to determine a predicted state or use (such as driving, cycling, etc.). For continuous monitoring of a sporting good, motion sensor data can be divided up into sections of data (such as 5 second sections), which can be compared to the model for evaluation of each successive section of data. The model's predictions can also be combined with rules for determining state transitions to determine the current state of the bike as disclosed herein throughout. For example, once motion of a sporting good is detected, the first 10 sections of data can yield 10 predictions of the state of the sporting good based on the model. The average or majority state found in the 10 predictions can be used to determine the state by the system. Using averages of multiple sections of data also helps prevent inaccurate outlier data from affecting a state determination. In addition, rules may be used to prevent inaccurate state changes. For example, a state change may not be allowed while a bike is currently cycling unless the bicycle stops, as one cannot transition from cycling to driving while cycling at 20 mph. After the initial determination but prior to the bike stopping, subsequent model evaluations can be used to enhance confidence in the initial prediction.

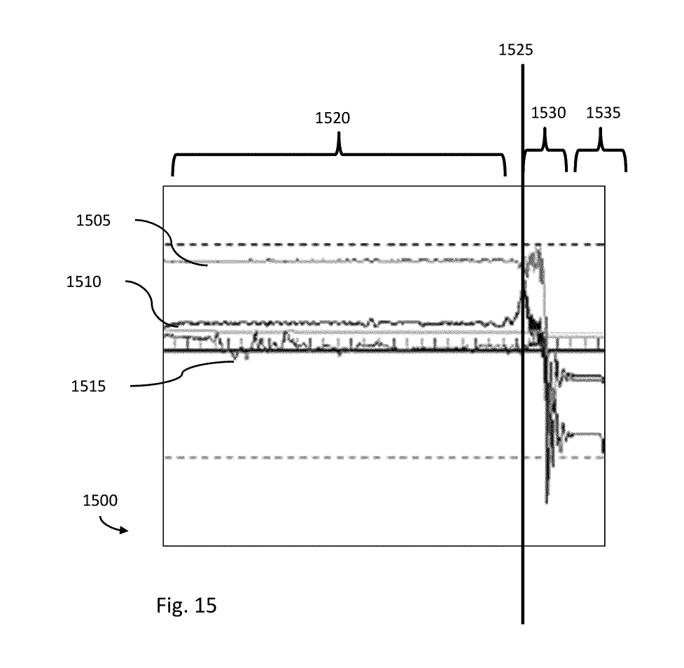

FIG. 15 shows an example graph 1500 of motion sensor data of a bicycle that has experienced a sideways crash. The graph 1500 includes x, y, and z accelerometer data lines 1510, 1515, and 1505 respectively. A bracket 1520 shows where a bicycle is in a cycling state and the bicycle is upright. A line 1525 shows where an acceleration threshold is exceeded, indicating a potential adverse event. A bracket 1530 shows crash data. A bracket 1535 shows the post-crash data, with data indicating that the bicycle is laying down. Such data may be used as disclosed herein to detect a crash.

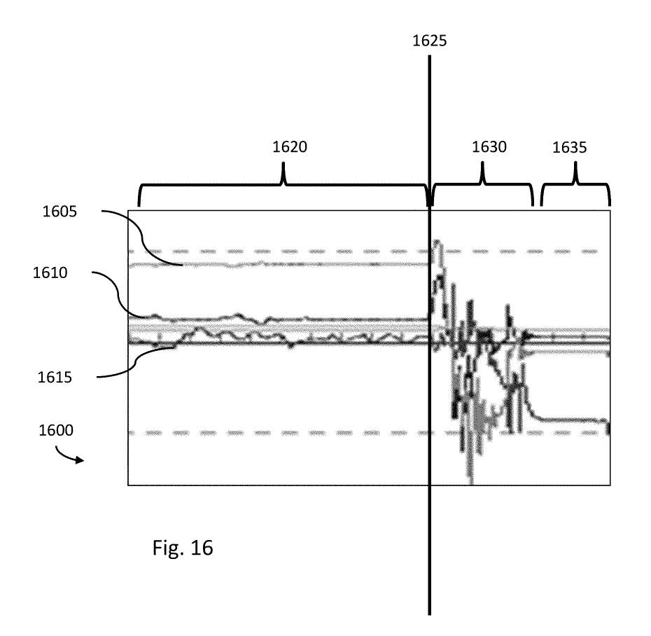

FIG. 16 shows an example graph 1600 of motion sensor data of a bicycle that has experienced an end-over-end crash. The graph 1600 includes x, y, and z accelerometer data lines 1610, 1615, and 1605 respectively. A bracket 1620 shows where a bicycle is in a cycling state and the bicycle is upright. A line 1625 shows where an acceleration threshold is exceeded, indicating a potential adverse event. A bracket 1630 shows crash data. A bracket 1635 shows the post-crash data, with data indicating that the bicycle is laying down. Such data may be used as disclosed herein to detect a crash.

The system may also record information for later use, such as for accident reconstruction or to further develop potential adverse event detection algorithms. The information may be recorded in the memory 830 of the server 825 of FIG. 8, for example. The system may also provide to a user device, such as the user device 800 of FIG. 8, condition ratings about a road, trail, path surface, body of water, etc. Such ratings may be sourced from inputs by other users and may include third party sources such as weather data or geo-spatial data such as road type, speed limit, etc. In some implementations, the system may be able to determine a type of activity the user is engaged in based at least in part on the location of the user or other information known to the system. For example, if the user is in the middle of a street, the system can deduce that the user is not jet skiing. Similarly, if the user is in the middle of a lake and the weather is −20 (minus twenty) degrees Celsius and has been for the last three months, the system can deduce that such a user is also not jet skiing.

In other implementations, the system may determine a danger score based on a route planned or taken by the user. For example, using the information known or available to the system such as various geofences on or near a planned route, the system can determine a relative safe-ness of various routes.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

In some implementations, any of the operations described herein can be implemented at least in part as computer-readable instructions stored on a computer-readable medium or memory. Upon execution of the computer-readable instructions by a processor, the computer-readable instructions can cause a computing device to perform the operations.

The foregoing description of some implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A method according to a set of instructions stored on the memory of a computing device, the method comprising:
receiving, by a processor of the computing device, first motion sensor data of a motion sensor associated with a sporting good;
in response to the first motion sensor data, automatically activating, by the processor, an activity monitoring application logic comprising:
receiving, by the processor, a second motion sensor data of the motion sensor after the activity monitoring application logic is activated;
processing, by the processor, the second motion sensor data to identify a pattern of motion indicative of active usage of the sporting good;
in response to identifying the active usage, automatically activating, by the processor, adverse event detection logic comprising:
receiving, by the processor, third motion sensor data of the motion sensor; and
monitoring, by the processor, the third motion sensor data to detect a potential adverse event experienced by the sporting good.

2. The method of claim 1, wherein the activity monitoring application logic is automatically activated based at least in part on a determination that the first motion sensor data indicates that the sporting good has moved.

3. The method of claim 1, further comprising: in response to determining the potential adverse event, monitoring the third motion sensor data for indicia of a return to active usage of the sporting good.

4. The method of claim 3, further comprising: in response to a failure to detect the return to active usage of the sporting good within a threshold amount of time, initiating an adverse event notification process.

5. The method of claim 4, further comprising: in response to initiation of the adverse event notification process, sending an adverse event alert to a predetermined emergency contact, and further wherein the adverse event alert comprises a location of the motion sensor.

6. The method of claim 1, wherein the potential adverse event is detected by processing the third motion sensor data to obtain an orientation of the sporting good indicative of the potential adverse event.

7. The method of claim 1, wherein the pattern of motion indicative of active usage of the sporting good is identified at least in part based on a speed of the sporting good or an acceleration of the sporting good in at least one direction.

8. The method of claim 1, further comprising:
sending, by the processor, an opt out request to a user device in response to detection of the potential adverse event;
re-activating, by the processor, the activity monitoring application logic in response to reception of an opt out confirmation within a first threshold of time; and
initiating, by the processor, an adverse event notification process in response to a failure to receive an opt out confirmation from the user device within a second threshold amount of time.

9. The method of claim 1, wherein processing the second motion sensor data to identify the pattern of motion indicative of active usage comprises identifying a pattern of motion indicative of a pedaling cadence on a bicycle.

10. The method of claim 9, wherein the pattern of motion indicative of the pedaling cadence comprises at least one of an acceleration characteristic of a down stroke on a bicycle and an acceleration characteristic of a side-to-side motion of the bicycle.

11. The method of claim 1, wherein processing the second motion sensor data to identify the pattern of motion indicative of active usage of the sporting good comprises analyzing the motion data using a predictive model.

12. A system comprising:
a memory; and
a processor coupled to the memory, wherein the processor is configured to:
receive first motion sensor data of a motion sensor associated with a sporting good;
in response to the first motion sensor data, automatically activate an activity monitoring application logic, wherein in the activity monitoring application logic the processor is further configured to:
receive a second motion sensor data of the motion sensor after the activity monitoring application logic is activated;
process the second motion sensor data to identify a pattern of motion indicative of active usage of the sporting good;
in response to identification of the active usage, automatically activate adverse event detection logic, wherein in the adverse event detection logic the processor is further configured to:
receive third motion sensor data of the motion sensor; and
monitor the third motion sensor data to detect a potential adverse event experienced by the sporting good.

13. The system of claim 12, further comprising a user device configured to wirelessly communicate with the motion sensor, wherein the activity monitoring application logic is activated only if the user device communicates with the motion sensor to indicate to the processor a proximity between the motion sensor and the user device.

14. The system of claim 13, wherein the user device is configured to:
receive the first motion sensor data, the second motion sensor data, and the third motion sensor data; and
send the first motion sensor data, the second motion sensor data, and the third motion sensor data to the processor.

15. The system of claim 13, wherein the processor is further configured to receive user motion data from the user device.

16. The system of claim 15, wherein the processor is further configured to automatically activate the activity monitoring application logic in response to the user motion data.

17. The system of claim 15, wherein the processor is further configured to automatically activate the adverse event detection logic in response to the user motion data.

18. The system of claim 12, further comprising a vehicle device configured to wirelessly communicate with the motion sensor, wherein the activity monitoring application logic is not activated if the vehicle device communicates with the motion sensor to indicate to the processor a proximity between the motion sensor and the vehicle device.

19. The system of claim 18, wherein the processor is further configured to:
receive, from the vehicle device, vehicle location information;
determine, based on the vehicle location information, a vehicle route; and
determine, based on the vehicle route, a potential hazard in the vehicle route.

20. The system of claim 19, wherein the processor is further configured to send to the vehicle device a potential hazard alert comprising a type and a location of the potential hazard.

21. The system of claim 12, wherein the processor is further configured to analyze the motion data using a predictive model to process the second motion sensor data to identify the pattern of motion indicative of active usage of the sporting good.

22. The system of claim 12, wherein the processor is further configured to:
send an opt out request to a user device in response to detection of the potential adverse event;
re-activate the activity monitoring application logic in response to reception of an opt out confirmation within a first threshold of time; and
initiate an adverse event notification process in response to a failure to receive an opt out confirmation from the user device within a second threshold amount of time.

23. A non-transitory computer readable medium having instructions stored thereon that, upon execution by a computing device, cause the computing device to perform operations comprising:
receiving first motion sensor data of a motion sensor associated with a sporting good;
in response to the first motion sensor data, automatically activating an activity monitoring application logic comprising:
receiving a second motion sensor data of the motion sensor after the activity monitoring application logic is activated;
processing the second motion sensor data to identify a pattern of motion indicative of active usage of the sporting good;
in response to identifying the active usage, automatically activating adverse event detection logic comprising:
receiving third motion sensor data of the motion sensor; and
monitoring the third motion sensor data to detect a potential adverse event experienced by the sporting good.

24. The non-transitory computer readable medium of claim 23, wherein the instructions further cause the computing device to perform operations comprising: in response to detecting the potential adverse event, sending an opt out request to a user device.

25. The non-transitory computer readable medium of claim 23, wherein the instructions further cause the computing device to perform operations comprising:
receiving an opt out confirmation from the user device indicating a return to active usage of the sporting good; and
in response to receiving the opt out confirmation, re-activating the activity monitoring application logic.

26. The non-transitory computer readable medium of claim 23, wherein the instructions further cause the computing device to perform operations comprising:
in response to a failure to receive an opt out confirmation from the user device within a threshold amount of time, initiating an adverse event notification process; and
in response to initiation of the adverse event notification process, sending an adverse event alert to a predetermined emergency contact.

27. The non-transitory computer readable medium of claim 23, wherein processing the second motion sensor data to identify the pattern of motion indicative of active usage of the sporting good comprises analyzing the motion data using a predictive model.
